(19) United States
(12) Patent Application Publication
(10) Pub. No.: US 2013/0092860 A1
(43) Pub. Date: Apr. 18, 2013

(54) FLUID CONTROL VALVE

(71) Applicant: AISIN SEIKI KABUSHIKI KAISHA, Kariya-shi (JP)

(72) Inventors: Nobutaka KIKU, Okazaki-shi (JP); Koichi Kashiwagi, Toyokawa-shi (JP)

(73) Assignee: AISIN SEIKI KABUSHIKI KAISHA, Kariya-shi (JP)

(21) Appl. No.: 13/650,979

(22) Filed: Oct. 12, 2012

(30) Foreign Application Priority Data
Oct. 14, 2011 (JP) 2011-226335
Oct. 14, 2011 (JP) 2011-226336

(51) Int. Cl. F16K 5/00

(52) U.S. Cl. 251/314

(57) ABSTRACT

A fluid control valve includes: a valve housing having an inlet port and an outlet port; a drive source mounted on the valve housing; a valve shaft configured to be moved by the drive source; and a valve member mounted so as to extend radially with respect to an axial center of the valve shaft, wherein the valve member includes: a valve frame having a cylindrical portion configured to allow insertion of the valve shaft, and a seal member mounted on the extending portion and configured to be capable of coming into abutment with the valve seat, a portion of the valve shaft housed in the mounting portion is formed with a through hole in the direction orthogonal to the axial center, and a rotatable spherical body is arranged in the through hole, and the mounting portion is fixed to the spherical body by caulking.

### TECHNICAL FIELD

This disclosure relates to a fluid control valve configured to control a flow of fluid.

### BACKGROUND DISCUSSION

A poppet-valve-type opening and closing valve having a circular valve body mounted vertically to a valve shaft and configured to be seated on a perfect circular-shaped valve seat by the movement of the valve body in the axial direction together with the valve shaft is widely used historically in an intake and exhaust valve or the like of an internal combustion engine.

An opening and closing valve disclosed in JP-2008-146924A (Reference 1) is provided on an oxidation gas supply channel of a fuel cell system and selectively introduces air to a pair of pressure chambers divided by a diaphragm from each other. Accordingly, the valve body connected to the diaphragm is brought into abutment with or moved away from the valve seat formed on the supply channel to connect and disconnect the supply channel.

The poppet-valve-type opening and closing valve disclosed in the related art has a high bearing strength with respect to a high pressure from one direction when the valve is closed and hence is capable of sealing high-pressure oxidation gas discharged from an air compressor sufficiently.

However, in contrast, in the poppet-valve-type opening and closing valve described above, variations in accuracy in parallelism between a planar direction of the valve body and a seal surface of the valve seat may occur due to errors in terms of design or manufacture. When there are such variation in accuracy of the parallelism between the valve body and the seal surface of the valve seat coming into abutment with each other, a sealing failure of the opening and closing valve may be resulted, and hence a countermeasure for avoiding the sealing failure is necessary.

In order to do so, when the valve body is seated on the valve seat, the variations in parallelism between the valve body and the valve seat are absorbed by partly collapsing a seal member formed of a resilient material thus far. Accordingly, even through the valve body and the seal surface of the valve seat are not parallel to each other, the seal member comes into abutment with the entire surface of the valve seat, and the sealing failure of the opening and closing valve may be prevented.

However, the opening and closing valve disclosed in JP-2008-146924A (Reference 1) is required to allow passage of a predetermined amount of fluid, and the seal member needs to have a certain seal diameter. Therefore, when the seal diameter is increased, the crushing margin of the seal member needs to be increased, and a load to press the valve body also needs to be increased. Therefore, the opening and closing valve by itself is increased in size and hence there is a problem of an increase in cost.

In contrast, in the opening and closing valve disclosed in JP-62-87275UM (Reference 2), an upper portion of a valve body mounting shaft on which the valve body seated on the valve seat is mounted and a lower portion of a main shaft are connected by a coupling pin inserted in the direction vertical to axes of the both. In this configuration, since the valve body mounting shaft is coupled to the main shaft so as to be capable of oscillating, the valve body may be faced in conformity to the seal surface of the valve seat to secure a sealing force therebetween even though the main shaft is not vertical to the seal surface of the valve seat.

However, in the opening and closing valve disclosed in JP-62-87275UM (Reference 2), the valve body mounting shaft and the main shaft are connected via the coupling pin, and since rattling between the valve body mounting shaft and the main shaft is determined by dimensions of the three components, that is, the valve body mounting shaft, the main shaft, and the coupling pin, the rattling therebetween may be increased. If the degree of rattling between the valve body mounting shaft and the main shaft is large, vibrations of the valve body and a noise in association therewith are increased, and variation in flow rate in the fluid passing through the opening and closing valve may be generated.

In particular, when the degree of the rattling in the axial direction between the valve body mounting shaft and the main shaft is large, hysteresis may be generated in a flow rate characteristic of the opening and closing valve. Therefore, when the opening and closing valve is used for the fluid control valve that controls the flow rate of the fluid, accurate control of the flow rate of the fluid is associated with difficulty.

In contrast, if an attempt is made to reduce the rattling between the valve body mounting shaft and the main shaft, improvement of dimensional accuracies of the respective components is required, which forces an increase in cost.

In addition, if there is a fear of entry of moisture or foreign substances in the opening and closing valve, a seal member configured to cover an entire oscillating mechanism in order to protect the oscillating mechanism of the opening and closing valve therefrom. Therefore, the opening and closing valve is further increased in size by the seal member, which results in a further cost increase.

### SUMMARY

In view of such circumstances, it is an object of this disclosure to provide a compact and low cost fluid control valve configured to generate a sealing force reliably between a valve member and a valve seat when the valve is closed.

According to an aspect of this disclosure, there is provided a fluid control valve including: a valve housing having an inlet port and an outlet port for fluid formed in the interior thereof; a drive source mounted on the valve housing; a valve shaft configured to be moved by the drive source in the axial direction in the valve housing; and a valve member mounted so as to extend radially with respect to an axial center of the valve shaft, configured to be seated on or moved away from a valve seat formed in the valve housing on one surface by moving together with the valve shaft to connect and disconnect between the inlet port and the outlet port, wherein the valve member includes: a valve frame having a cylindrical portion configured to allow insertion of the valve shaft in a state in which a radial gap is formed with respect to the valve shaft, an extending portion spreading radially from the cylindrical portion to the valve shaft, and a mounting portion continuing at one end thereof from the cylindrical portion or the extending portion, closed at the other end thereof in a bag shape, and having a distal end of the valve shaft housed therein and a seal member mounted on the extending portion and configured to be capable of coming into abutment with the valve seat, a portion of the valve shaft housed in the mounting portion is formed with a through hole in the direction orthogonal to the axial center, and a rotatable spherical body is arranged in the through hole, and the mounting portion is fixed to the spherical body by caulking.

Preferably, the portion of the valve shaft formed with the through hole is formed to have a diameter smaller than that of the portion inserted into the cylindrical portion, and the spherical body projects from both end portions of the through hole.

Preferably, the portion of the valve shaft formed with the through hole is formed into a width-across-flat shape having a pair of flat surfaces facing each other on an outer peripheral surface thereof, and the both end portions of the through hole are opened respectively so as to be orthogonal to the flat surfaces facing each other.

Preferably, the ring-shaped seal member is interposed between the outer peripheral surface of the valve shaft and an inner peripheral surface of the cylindrical portion.

According to a second aspect of this disclosure, there is provided a fluid control valve including: a valve housing having an inlet port and an outlet port for fluid formed in the interior thereof; a drive source mounted on the valve housing; a valve shaft configured to be moved by the drive source in the axial direction in the valve housing; a valve member mounted so as to extend radially with respect to an axial center of the valve shaft, configured to be seated on or moved away from a valve seat formed in the valve housing on one surface by moving together with the valve shaft to connect and disconnect between the inlet port and the outlet port, wherein the valve member includes: a valve frame having a cylindrical portion extending in the axial direction of the valve shaft and configured to allow insertion of the valve shaft, an extending portion spreading radially from the cylindrical portion to the valve shaft, and a mounting portion continuing at one end thereof from the cylindrical portion or the extending portion and closed at one end thereof in a bag shape and configured to receive a curved surface formed on a distal end portion of the valve shaft; and a seal member mounted on the extending portion and configured to be capable of coming into abutment with the valve seat, the valve shaft has a radial gap with respect to the cylindrical portion, is connected to the mounting portion so as not to be decoupled, and has a gap in the axial direction.

Preferably, the valve frame is formed by press-forming a metal plate, is configured to connect the valve member and the valve shaft by caulking the mounting portion after the distal end portion of the valve shaft is inserted, and forms the gap in the axial direction.

Preferably, the size of the gap in the radial direction between the valve shaft and the cylindrical portion is set on the basis of a seal diameter with respect to the valve seat of the seal member so that the valve member is inclined with respect to the valve shaft by a predetermined amount about the distal end portion of the valve shaft in conformity to the valve seat when the valve member is seated on the valve seat.

Preferably, a coil spring interposed between the valve member and the valve housing so as to surround the valve shaft in the circumferential direction and configured to urge the valve member toward a distal end of the valve shaft is provided.

Preferably, the ring-shaped seal member is resiliently interposed between the outer peripheral surface of the valve shaft and an inner peripheral surface of the cylindrical portion.

Preferably, an outer peripheral edge of a diaphragm having a mounting hole penetrating therethrough from the front to the back is fixed to an inner peripheral surface of the valve housing in a liquid-tight manner, and an inner peripheral edge of the mounting hole is fixed to an outer peripheral portion of the valve member in a liquid-tight manner, so that the interior of the valve housing is divided by the diaphragm and the valve member to form a fluid chamber having the inlet port, the outlet port, and the valve seat and configured to allow passage of the fluid, and an air chamber configured to prevent the fluid from entering therein.

### BRIEF DESCRIPTION OF THE DRAWINGS

FIG. 1 is a block diagram illustrating a fuel cell system according to Embodiment 1 disclosed here;

FIG. 2 is a partial cross-sectional view of an air pressure regulation valve illustrated in FIG. 1;

FIG. 3 is a partial cross-sectional view of the air pressure regulation valve illustrated in FIG. 2 when the valve is closed;

FIG. 4 is a simplified cross-sectional view illustrating an engaging state between an output shaft and a valve shaft of a stepping motor included in the air pressure regulation valve illustrated in FIG. 2;

FIG. 5 is a cross-sectional view taken along the line Iv-Iv in FIG. 4;

FIG. 6 is a perspective view illustrating a state when inserting the valve shaft into a mounting portion of a valve frame;

FIG. 7 is an enlarged view for explaining a case where a valve member is inclined in the direction of an axis of a ball hole;

FIG. 8 is an enlarged view for explaining a case where the valve member is inclined about the axis of the ball hole;

FIG. 9 is a cross-sectional view for explaining a modification of the air pressure regulation valve according to Embodiment 1;

FIG. 10 is a partial cross-sectional view illustrating a three-way valve according to Embodiment 2 disclosed here;

FIG. 11 is a partial cross-sectional view of a state when a bypass valve seat of the three-way valve illustrated in FIG. 10 is closed;

FIG. 12 is a partial cross-sectional view of a state when a control valve seat of the three-way valve illustrated in FIG. 10 is closed;

FIG. 13 is a partial cross-sectional view of the air pressure regulation valve illustrated in FIG. 1;

FIG. 14 is a partial cross-sectional view of the air pressure regulation valve illustrated in FIG. 13 when the valve is closed;

FIG. 15 is a simplified cross-sectional view illustrating an engaging state between the output shaft and the valve shaft of the stepping motor included in in the air pressure regulation valve illustrated in FIG. 13;

FIG. 16 is a cross-sectional view taken along the line XVI-XVI in FIG. 15;

FIG. 17 is a simplified drawing illustrating a method of caulking a valve frame on the valve shaft;

FIG. 18 is an enlarged cross-sectional view illustrating a connecting portion between the valve shaft and the valve frame of the air pressure regulation valve;

FIG. 19 is a schematic view for explaining a relation between a seal diameter and an absorbable height of the valve member;

FIG. 20 is a drawing showing a graph for explaining a method of setting an angle of inclination of the valve member;

FIG. 21 is a process drawing for explaining a modification of the air pressure regulation valve according to Embodiment 3;

FIG. 22 is a partial cross-sectional view illustrating the three-way valve according to a fourth embodiment disclosed here;

FIG. 23 is a partial cross-sectional view of a state when the bypass valve seat of the three-way valve illustrated in FIG. 22 is closed; and

FIG. 24 is a partial cross-sectional view of a state when the control valve seat of the three-way valve illustrated in FIG. 22 is closed.

### DETAILED DESCRIPTION

### Embodiment 1

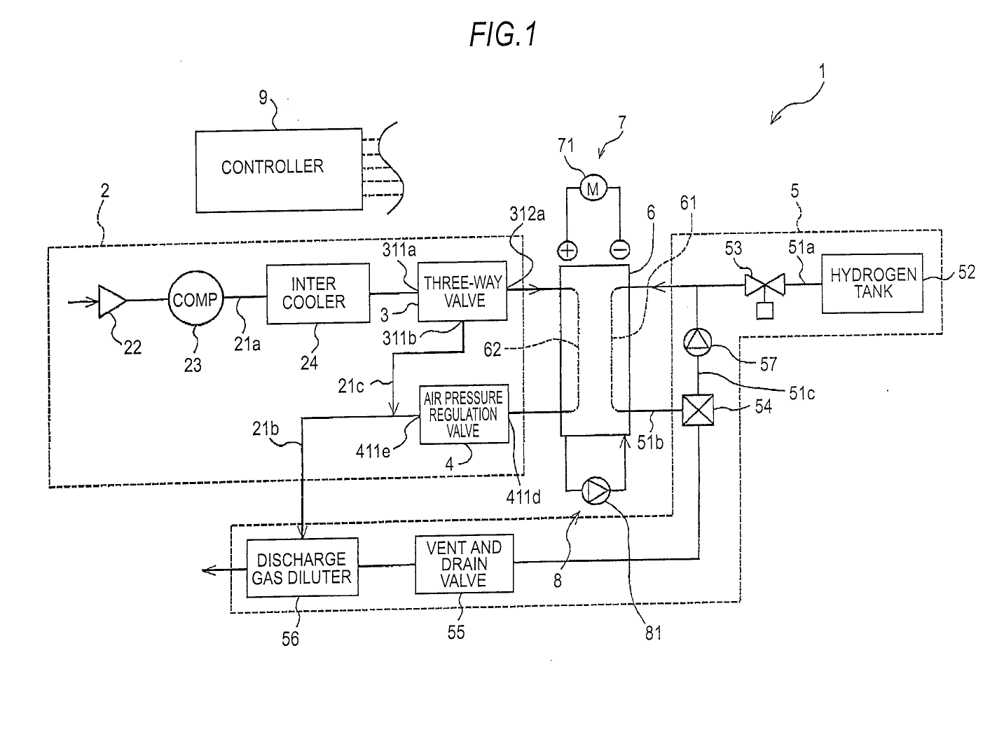

Referring to FIG. 1 to FIG. 9, an air pressure regulation valve 4 according to Embodiment 1 disclosed here will be described.

As illustrated in FIG. 1, the air pressure regulation valve 4 (which corresponds to a fluid control valve) according to the embodiment is applied to an oxygen system 2 of a fuel cell system 1 mounted on a vehicle. However, the invention is not limited thereto, and the air pressure regulation valve 4 may be used widely as a vehicle fluid control valve such as a fuel supply system or a hydraulic brake system, and may be applied as a fluid control valve for household appliances or general industrial machines.

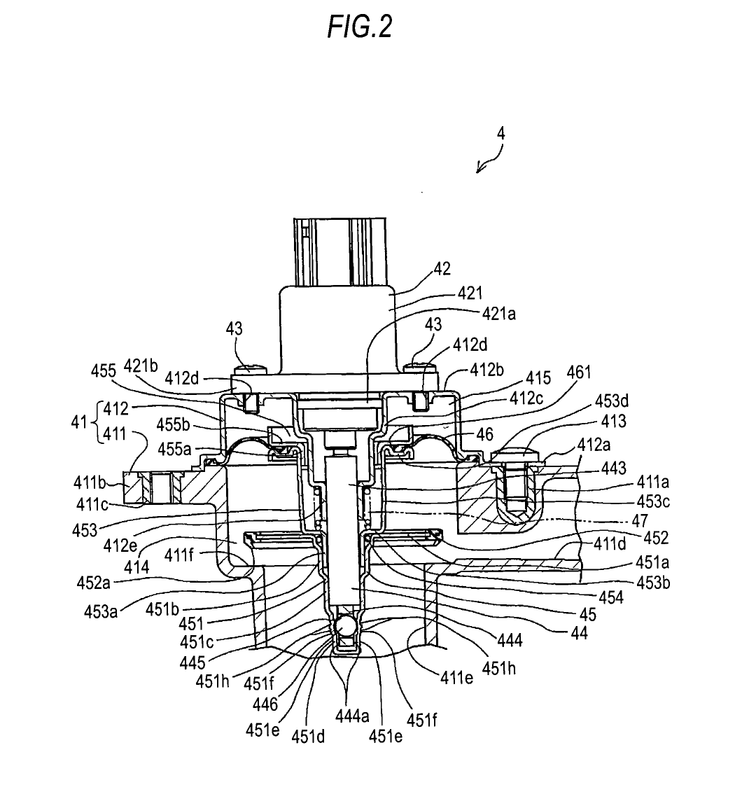

Upside and lower side in FIG. 2 are defined as upside and lower side of the air pressure regulation valve 4, and right side and left side in FIG. 2 correspond to right side and left side of the air pressure regulation valve 4, respectively, in the description given below. However, these orientations have no relation to actual mounting directions of the air pressure regulation valve 4 in the vehicle.

As illustrated in FIG. 1, the fuel cell system 1 includes the oxygen system 2, a fuel system 5, a cell stack 6, a power system 7, a cooling system 8, and a control apparatus 9.

The cell stack 6 is formed by stacking a plurality of solid-polymer-type single cells, although not limited thereto. The plurality of single cells are connected electrically in series, and each of the single cells includes an electrolyte film, and an anode pole and a cathode pole (both not illustrated) arranged so as to interpose the electrolyte film therebetween. An anode flow channel 61 for supplying hydrogen gas to the anode pole is formed on an anode separator (not illustrated) of the single cell, and a cathode flow channel 62 for supplying air to the cathode pole is formed on a cathode separator (not illustrated).

The oxygen system 2 includes an oxygen system supply pipe 21a, and the oxygen system supply pipe 21a is connected to one end of the cathode flow channel 62 in the cell stack 6. An air filter 22, an air compressor 23, an inter cooler 24, and a three-way valve 3 are formed on the oxygen system supply pipe 21a in this order toward the cell stack 6.

One end of an oxygen system discharging pipe 21b is connected to the other end of the cathode flow channel 62, and the air pressure regulation valve 4 as a two-port fluid control valve is provided on the oxygen system discharging pipe 21b. The above-described three-way valve 3 is a three-port fluid control valve, to which one end of a bypass conduit line 21c is connected and the other end of the bypass conduit line 21c is connected to a downstream side portion (the side where the cell stack 6 is not connected) with respect to the air pressure regulation valve 4 of the oxygen system discharging pipe 21b.

In contrast, in the fuel system 5, a hydrogen tank 52 is connected to one end of a fuel system supply pipe 51a, and a cutoff valve 53 is formed on the fuel system supply pipe 51a. The other end of the fuel system supply pipe 51a is connected to one end of the anode flow channel 61 in the cell stack 6. A fuel system discharge pipe 51b is connected to the other end of the anode flow channel 61, and a gas-liquid separator 54, a vent and drain valve 55, and a discharge gas diluter 56 are formed on the fuel system discharge pipe 51b in this order from the side closer to the cell stack 6. The other end of the above-described oxygen system discharging pipe 21b is connected to the discharge gas diluter 56.

The gas-liquid separator 54 is connected to a connecting portion between the cutoff valve 53 on the fuel system supply pipe 51a and the anode flow channel 61 via a fuel system circulation channel 51c. A circulation pump 57 is provided on the fuel system circulating channel 51c to cause hydraulic gas to circulate from the gas-liquid separator 54 toward the anode flow channel 61.

The power system 7 includes an electric motor 71 for causing the vehicle to travel. The electric motor 71 is connected to a positive electrode and a negative electrode of the cell stack 6 and is driven by power generation of the cell stack 6.

The cooling system 8 is provided with a water-cooled pump 81, and causes cooling water to circulate in the cell stack 6 to cool the cell stack 6.

The control apparatus 9 is electrically connected to the air compressor 23, the three-way valve 3, the air pressure regulation valve 4, the cutoff valve 53, the circulation pump 57, and the water-cooled pump 81. The control apparatus 9 controls the operation of the respective components as described above on the basis of a required electric-generating capacity of the cell stack 6 calculated in accordance with a state of traveling of the vehicle.

With the configuration described above, when the vehicle starts operation, the control apparatus 9 activates the air compressor 23 to supply air to the cathode flow channel 62 and activates the cutoff valve 53 and the circulation pump 57 to supply hydrogen gas to the anode flow channel 61 to generate power in the cell stack 6.

In the oxygen system 2, the air containing oxygen sucked via the air filter 22 is compressed by the air compressor 23, and then is cooled by the inter-cooler 24. The three-way valve 3 displaces the position of the valve member according to the electric-generating capacity of the cell stack 6 to split air supplied from the inter cooler 24 and release the same to the bypass conduit line 21c, whereby the flow rate of the air to the cell stack 6 is controlled.

The air pressure regulation valve 4 also controls a pressure in the cell stack 6 by regulating the opening degree thereof and adjusting the amount of discharge of air remaining in the cell stack 6.

Hydrogen off gas (fuel-gas-off gas) discharged from the anode flow channel 61 includes hydrogen gas which has not been used for power generation and water (moisture vapor) generated by power generation. The gas-liquid separator 54 includes a function to separate hydrogen gas and water. The hydrogen gas separated by the gas-liquid separator 54 is supplied via the fuel system circulating channel 51c to the fuel system supply pipe 51a by the circulation pump 57 and circulated. Water (liquid) separated by the gas-liquid separator 54 is sent to the discharge gas diluter 56 together with hydrogen gas when the vent and drain valve 55 is brought into an opened state. The hydrogen gas discharged from the gas-liquid separator 54 to the discharge gas diluter 56 is diluted by air supplied from the oxygen system discharging pipe 21b in the discharge gas diluter 56 and discharged therefrom to the outside together with water.

Subsequently, the structure of the air pressure regulation valve 4 will be described in detail. As illustrated in FIG. 2, the air pressure regulation valve 4 is formed by mounting a motor assembly 42 (which corresponds to a drive source) to an outer peripheral surface of a valve housing 41. The valve housing 41 is formed by joining a valve body 411 formed of a synthetic resin material such as polyphenylene sulphide and a valve cover 412 formed integrally of a metallic plate to each other. In this embodiment, the motor assembly 42 employing an electric motor is used as a drive source. However, a solenoid actuator or an actuator driven by a gas pressure may be used.

A cover mounting sleeve 411a formed of a metal for mounting the valve cover 412 is inserted into the valve body 411. A metal sleeve 411c for mounting the air pressure regulation valve 4 to the vehicle is inserted into a flange portion 411b of the valve body 411. A female screw thread is formed on each of inner peripheral surfaces of the cover mounting sleeve 411a and the metal sleeve 411c.

The valve body 411 is formed with a pressure regulation valve inlet 411d (which corresponds to an inlet port) opening rightward in FIG. 2. The pressure regulation valve inlet 411d is connected to the other end of the cathode flow channel 62 of the cell stack 6 via the above-described oxygen system discharging pipe 21b (illustrated in FIG. 1). The valve body 411 is formed with a pressure regulation valve outlet 411e (which corresponds to an outlet port) opening in the vertical direction with respect to the pressure regulation valve inlet 411d (opening downward in FIG. 2). The pressure regulation valve outlet 411e is connected to the discharge gas diluter 56 via the oxygen system discharging pipe 21b described above.

On an inner peripheral surface of the valve body 411, a pressure regulation valve seat 411f (which corresponds to a valve seat) is formed between the pressure regulation valve inlet 411d and the pressure regulation valve outlet 411e. The pressure regulation valve seat 411f is formed into a flat circular ring shape.

The valve cover 412 is mounted on an upper end surface of the valve body 411 by tightening a mounting bolt 413 penetrated therethrough into the cover mounting sleeve 411a. The valve cover 412 includes a mounting surface 412a with respect to the valve body 411, a motor mounting portion 412b projecting upward from the mounting surface 412a, and a shaft housing 412c stepwise lowered at a center portion of the motor mounting portion 412b and having an opened lower end portion. A plurality of female screw thread holes 412d are provided on an upper surface of the motor mounting portion 412b. The valve cover 412 includes the above-described mounting surface 412a, the motor mounting portion 412b, and the shaft housing 412c formed integrally by press-molding a metal plate.

The above-described motor assembly 42 is mounted on an upper surface of the motor mounting portion 412b. The motor assembly 42 is fixed to the valve cover 412 by tightening a plurality of mounting screws 43 penetrated through mounting flanges 421b into the female screw thread holes 412d of the motor mounting portion 412b in a state in which an outer peripheral surface of a mechanism housing 421a of a motor case 421 fitted into an inner peripheral surface of the shaft housing 412c. The mounting screws 43 are loosely fitted into through holes (not illustrated) formed in the mounting flanges 421b, and positioning of the valve cover 412 is achieved by abutment of the inner peripheral surface of the shaft housing 412c with the outer peripheral surface of the mechanism housing 421a

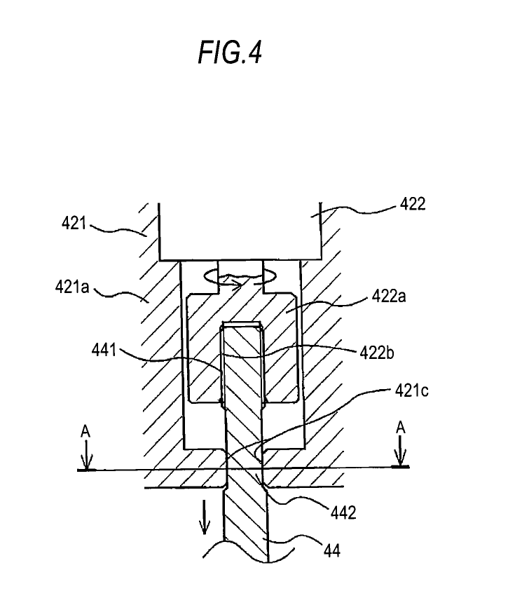

As illustrated in FIG. 4, a stepping motor 422 is fixed to an inner wall of the motor case 421. A distal end of an output shaft 422a of the stepping motor 422 has a cylindrical shape, and a drive hole 422b is formed at an axial center thereof. A female screw thread having a predetermined length is formed on an inner peripheral surface of the drive hole 422b, and engages a male screw thread portion 441 formed on an outer peripheral surface of an end portion of a valve shaft 44 (which corresponds to a valve shaft).

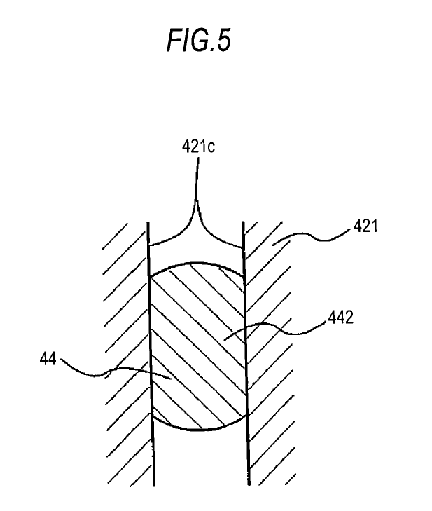

The valve shaft 44 is formed of a metallic material such as stainless, and a width-across-flat portion 442 is formed below the male screw thread portion 441. The width-across-flat portion 442 engages a pair of opposed surface 421c formed at a lower end portion of the motor case 421, whereby the valve shaft 44 is prohibited from rotating with respect to the motor case 421 (illustrated in FIG. 5). Therefore, when the output shaft 422a of the stepping motor 422 rotates in one direction, the valve shaft 44 is moved downward in the axial direction in the valve housing 41, and when the output shaft 422a rotates in the opposite direction, the valve shaft 44 is moved upward.

Preferably, the male screw thread portion 441 of the valve shaft 44 described above and the female screw thread on the output shaft 422a are each formed of a trapezoidal screw, and backward efficiency between the valve shaft 44 and the output shaft 422a is set to approximately zero. Accordingly, transmission of operation between the valve shaft 44 and the output shaft 422a is formed irreversibly, and when a returning load acts from the valve shaft 44 toward the output shaft 422a in a state in which the air pressure regulation valve 4 is closed, the output shaft 422a does not rotate in the direction of opening the valve, and hence the air pressure regulation valve 4 is prevented from opening accidentally.

As illustrated in FIG. 2, a cylindrical portion 443 projecting from the motor case 421 and extending from the motor case 421 in the axial direction so as to have a constant diameter is formed below the width-across-flat portion 442 of the valve shaft 44. An outer peripheral surface of the cylindrical portion 443 is supported by a shaft retainer portion 412e formed at a lower end of the shaft housing 412c of the valve cover 412 so as to be movable in the axial direction. The outer peripheral surface of the cylindrical portion 443 and the shaft retainer portion 412e in abutment with each other are plated by electroless nickel plating or the like to improve abrasion resistance of a sliding surface therebetween.

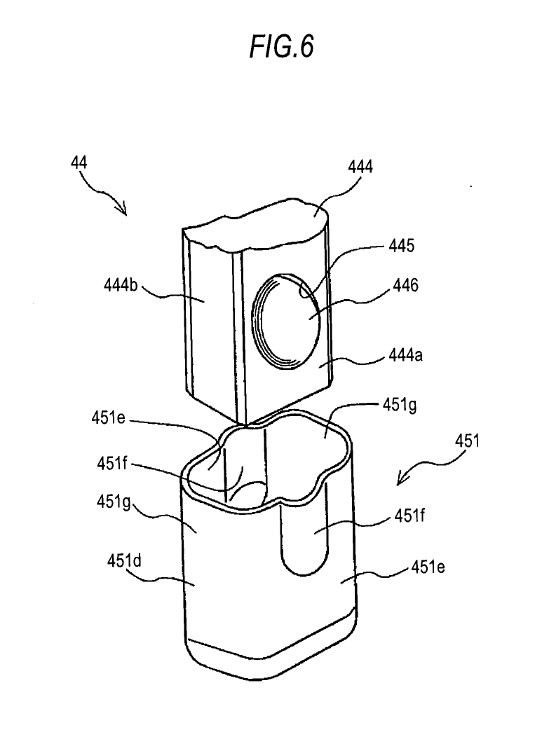

In addition, a coupling portion 444 (which corresponds to a portion housed in the mounting portion) formed to have a diameter smaller than that of the cylindrical portion 443 is integrally formed at a distal end portion of the cylindrical portion 443. The coupling portion 444 is formed into a width-across-flat shape having a pair of flat surfaces 444a (only one of these surfaces is illustrated in FIG. 6) facing each other on an outer peripheral surface thereof. The flat surfaces 444a are connected to each other by a pair of side surface portions 444b (only one of these surfaces is illustrated in FIG. 6) facing each other.

The coupling portion 444 is formed with a ball hole 445 (which corresponds to a through hole) penetrating in a direction orthogonal to an axial center, and both end portions of the ball hole 445 are opened so as to be orthogonal to the flat surfaces 444a facing to each other. A steel ball 446 (which corresponds to a spherical body) is arranged in the ball hole 445. The diameter of the steel ball 446 is set to be larger than the distance between the flat surfaces 444a (the thickness of the width-across-flat), and the steel ball 446 projects from both end portions of the ball hole 445. The diameter of the steel ball 446 is slightly smaller than the diameter of the ball hole 445, and the steel ball 446 is rotatable within the ball hole 445, and is housed so as to be movable in the axial direction of the ball hole 445 within the ball hole 445.

A valve member 45 is mounted on the steel ball 446 provided at a distal end portion of the valve shaft 44 so as to extend in the radial direction with respect to an axial center of the valve shaft 44. A valve frame 451 of the valve member 45 is formed of a metal plate such as stainless by press forming. The valve frame 451 includes a flat plate portion 451a extending in a disk shape in the radial direction with respect to the axial center of the valve shaft 44, and a seal member 452 is secured to the flat plate portion 451a so as to cover an outer peripheral edge thereof.

The seal member 452 is formed of a synthetic rubber material having heat resistance such as SBR (styrene-butadiene rubber) or EPDM (ethylene-propylene-diene copolymer). A seal lip 452a configured to be capable of abutting against the pressure regulation valve seat 411f formed on the valve body 411 by a downward movement of the valve member 45 project from a lower surface of the seal member 452. As illustrated in FIG. 2, the seal lip 452a is formed radially inward (toward the pressure regulation valve outlet 411e) so as to achieve self-sealing by a reaction between hydrogen gas remaining in the cell stack 6 and oxygen or a negative pressure generated by condensation of residual moisture caused by decrease in temperature of the cell stack 6 when power generation is stopped.

The valve frame 451 is formed with a continuous step portion 451b (a configuration including the flat plate portion 451a and the step portion 451b corresponds to an extending portion) is formed at a radially center of the flat plate portion 451a. The step portion 451b extends in the axial direction of the valve shaft 44, and steps in the radial direction are formed at two positions so as to be aligned in the axial direction.

The valve frame 451 includes a cylindrical portion 451c (which corresponds to a cylindrical portion) continuing at one end thereof from the step portion 451b. The cylindrical portion 451c extends in the vertical direction with respect to the flat plate portion 451a, and the cylindrical portion 443 of the valve shaft 44 is inserted therein. In addition, the valve frame 451 includes a mounting portion 451d which allows the coupling portion 444 of the valve shaft 44 to be housed therein by being formed so as to be continuous to the other end of the cylindrical portion 451c and closed at a distal end thereof is closed in a bag shape.

As illustrated in FIG. 6, the mounting portion 451d includes a pair of fixed walls 451e so as to face respectively the flat surfaces 444a of the coupling portion 444 when the coupling portion 444 of the valve shaft 44 is housed therein. The respective fixed walls 451e are formed with fitting portions 451f so as to project therefrom, which allow the steel ball 446 to be housed when the coupling portion 444 is inserted into the mounting portion 451d. The mounting portion 451d is formed with a pair of connecting surface portions 451g facing each other so as to connect the fixed walls 451e.

The distance between inner peripheral surfaces of both of the fixed walls 451e is set to be larger than the distance between the flat surfaces 444a of the coupling portion 444 (the thickness of the width-across-flat), and the distance between inner peripheral surfaces of both of the connecting surface portions 451g is set to be larger than the distance between the side surface portions 444b of the coupling portion 444.

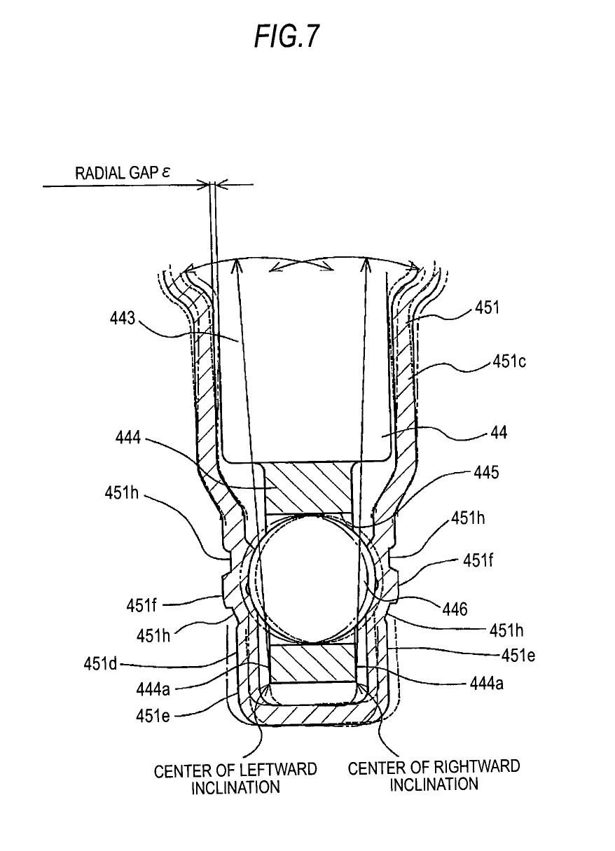

When the valve frame 451 is mounted on the valve shaft 44, the coupling portion 444 is inserted into the mounting portion 451d so that the steel ball 446 projecting from the flat surfaces 444a so as to be housed in the fitting portion 451f in a state in which the steel ball 446 is arranged in the ball hole 445 (illustrated in FIG. 6). Subsequently, caulked portions 451h are formed by caulking the both fixed walls 451e with respect to the steel ball 446, and the mounting portion 451d is fixed to the steel ball 446 (illustrated in FIG. 7).

When inserting the coupling portion 444 into the mounting portion 451d, positioning of the steel ball 446 is achieved by the fitting portions 451f, so that the coupling portion 444 may be inserted smoothly into the mounting portion 451d. As illustrated in FIG. 7, the caulking with respect to the steel ball 446 is performed at two positions; upper and lower positions, for each of the openings of the ball hole 445. After the fixed walls 451e are caulked, the steel ball 446 functions as a retainer for the valve shaft 44 with respect to the valve member 45.

As illustrated in FIG. 7, in a state in which the valve frame 451 is mounted on the valve shaft 44, only a minute gap exists in the axial direction, and substantial rattling in the vertical direction in FIG. 7 does not occur between the steel ball 446 and the ball hole 445 of the coupling portion 444.

In a state in which the valve frame 451 is mounted on the valve shaft 44, a gap ε in the radial direction with respect to the axial center of the valve shaft 44 (hereinafter, referred to as the radial gap ε) is formed between an inner peripheral surface of the cylindrical portion 451c and the outer peripheral surface of the cylindrical portion 443 of the inserted valve shaft 44. As illustrated in FIG. 7, the radial gap ε is formed over an entire circumference between the inner peripheral surface of the cylindrical portion 451c and the outer peripheral surface of the cylindrical portion 443. With the provision of the radial gap ε, the valve member 45 is formed so as to be capable of inclining with respect to the valve shaft 44.

When the valve member 45 mounted on the valve shaft 44 is inclined in the direction of penetration of the ball hole 445 (clockwise or counterclockwise in FIG. 7), the steel ball 446 integral with the valve frame 451 is rotatable in the ball hole 445, and is capable of moving leftward and rightward with respect to the axial direction of the ball hole 445 in the ball hole 445.

Therefore, when the valve member 45 is inclined leftward in FIG. 7, the valve member 45 may be inclined leftward until the gap ε between the right side of the inner peripheral surface of the cylindrical portion 451c and the right side of the outer peripheral surface of the cylindrical portion 443 is gone in a state in which the lower portion of the inner peripheral surface of the valve frame 451 is in abutment with a left corner (left end) of a lower end portion of the coupling portion 444 (indicated by a broken line in FIG. 7).

Also, when the valve member 45 is inclined rightward in FIG. 7, the valve member 45 may be inclined rightward until the gap ε between the left side of the inner peripheral surface of the cylindrical portion 451c and the left side of the outer peripheral surface of the cylindrical portion 443 is gone in a state in which the lower portion of the inner peripheral surface of the valve frame 451 is in abutment with a right corner (right end) of the lower end portion of the coupling portion 444 (indicated by a double-dashed line in FIG. 7).

Therefore, when the valve member 45 is inclined leftward and rightward in FIG. 7, a maximum angle of inclination of the valve member 45 is controlled on the basis of the radial gap ε and a radius of rotation about a corner at the lower end portion of the coupling portion 444.

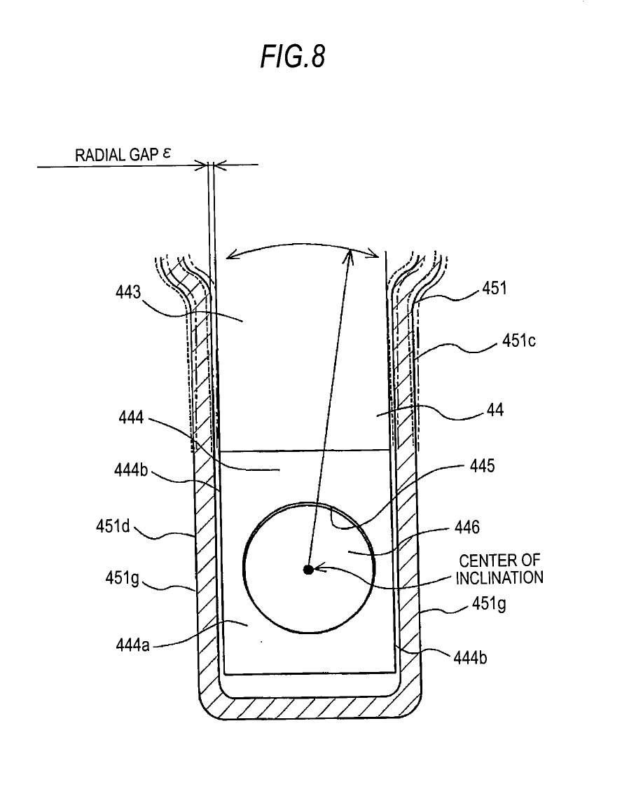

In contrast, when the valve member 45 is inclined in the direction in which the flat surfaces 444a of the coupling portion 444 extends (clockwise or counterclockwise in FIG. 8), the valve member 45 is capable of rotating about the axial center of the ball hole 445 (the center of the steel ball 446). In other words, by the rotation of the steel ball 446 integral with the valve frame 451 in the ball hole 445, the valve member 45 is inclined leftward or rightward (indicated by a broken line and a double-dashed chain line, respectively, in FIG. 8) until the gap ε between the inner peripheral surface of the cylindrical portion 451c and the outer peripheral surface of the cylindrical portion 443 is gone. Therefore, in this case, the maximum angle of inclination of the valve member 45 is controlled on the basis of the radial gap ε and a radius of rotation having a center at the axial center of the ball hole 445.

In this manner, the angle of inclination of the valve member 45 with respect to the valve shaft 44 is controlled by the radial gap ε in either direction of inclination.

The magnitude of the radial gap ε is set on the basis of the diameter of the seal portion with respect to the pressure regulation valve seat 411f of the seal member 452 so that the valve member 45 is inclined by a predetermined amount with respect to the valve shaft 44 in conformity to the pressure regulation valve seat 411f so as to achieve sealing when the valve member 45 is seated on the pressure regulation valve seat 411f of the valve body 411.

Returning back to FIG. 2, a spring retainer 453 is fixed to an inner peripheral surface of the step portion 451b of the valve frame 451 by being press-fitted thereto from above. The spring retainer 453 is formed by squeezing a metal plate by a press process. The spring retainer 453 includes a cylindrical fixing portion 453a positioned between a step formed below the step portion 451b and the cylindrical portion 443, and a shoulder portion 453b widening radially outward from the fixing portion 453a.

The fixing portion 453a of the spring retainer 453 is press-fitted to the inner peripheral surface of the step portion 451b of the valve frame 451 until the shoulder portion 453b comes into abutment with an upper surface of the flat plate portion 451a of the valve frame 451. The fixing portion 453a press-fitted into the step portion 451b has a gap from the outer peripheral surface of the cylindrical portion 443 of the valve shaft 44, and hence inclination of the valve member 45 with respect to the valve shaft 44 cannot be hindered.

An O-ring 454 as a seal member is interposed between a step formed above the step portion 451b and the fixing portion 453a. The O-ring 454 delivers a sealing performance between the valve frame 451 and the fixing portion 453a, and prevents entry of moisture or foreign substances entering into the air pressure regulation valve 4 to an air chamber 415 divided by the mounting portion 451d of the valve frame 451 or a diaphragm 46, described later.

Furthermore, the spring retainer 453 is provided with a coupling portion 453c extending upward from the shoulder portion 453b and a tightening portion 453d widening radially outward from the coupling portion 453c.

A diaphragm holding member 455 includes a engaging portion 455a extending in the axial direction of the valve shaft 44 at a radially inner end, and a pressing portion 455b extends radially from an upper end of the engaging portion 455a. The engaging portion 455a is press-fitted to an inner peripheral surface of the coupling portion 453c until a lower surface of the pressing portion 455b comes into abutment with an upper end of the coupling portion 453c of the spring retainer 453, whereby the spring retainer 453 and the diaphragm holding member 455 are integrated.

Between the tightening portion 453d of the spring retainer 453 and the pressing portion 455b of the diaphragm holding member 455, an inner peripheral edge of the diaphragm 46 is fixed. The diaphragm 46 is formed integrally of a synthetic rubber material, and a mounting hole 461 penetrating through from the front to the back is formed at a substantially center portion. A peripheral edge of the mounting hole 461 is pinched by the tightening portion 453d and the pressing portion 455b in the vertical direction, and is fixed therebetween in a liquid-tight manner.

An outer peripheral edge of the diaphragm 46 is pinched between an upper end surface of the above-described valve body 411 and a lower end of the motor mounting portion 412b of the valve cover 412, and is fixed in a liquid-tight manner. In this manner, by the diaphragm 46 mounted on an inner peripheral surface of the valve housing 41 and the valve member 45, the interior of the valve housing 41 is divided into two parts by the diaphragm 46 and the valve member 45. In other words, the interior of the valve housing 41 is formed with a fluid chamber 414 including the pressure regulation valve inlet 411d, the pressure regulation valve outlet 411e and the pressure regulation valve seat 411f and configured to allow passage of the supplied fluid, and the air chamber 415 prevented from entry of fluid or the like and filled with air. The air chamber 415 communicates with an outside air via a ventilation hole, not illustrated, provided in the valve cover 412.

A coil spring 47 is interposed between the shoulder portion 453b of the spring retainer 453 and the step portion of the shaft housing 412c of the valve cover 412 so as to surround the valve shaft 44 in the circumferential direction. The coil spring 47 is mounted resiliently between the spring retainer 453 and the valve cover 412, and urges the valve member 45 toward a distal end of the valve shaft 44.

When fluid such as air having a predetermined pressure is supplied from the pressure regulation valve inlet 411d into the valve housing 41, the above-described diaphragm 46 receives a pressure from the fluid, and an upper portion of the valve member 45 is pulled uniformly along the circumference thereof by the diaphragm 46 and is held without being displaced from the axial center of the valve shaft 44 (centering) and inclining with respect to the axial center of the valve shaft 44.

A lower portion of the valve member 45 is also held without being displaced from the axial center of the valve shaft 44 (centering) and inclining with respect to the axial center of the valve shaft 44 by an urging force of the coil spring 47 described above toward the distal end of the valve shaft 44 of the coil spring 47. Also, the gap between the steel ball 446 and the ball hole 445 in the vertical direction in a state in which the air pressure regulation valve 4 is opened is gone by the urging force of the coil spring 47, so that generation of vibrations of the valve member 45 and a noise in association therewith may be prevented.

By holding forces of the diaphragm 46 and the coil spring 47 as described above, generation of the vibrations of the valve member 45 and a noise in association therewith are prevented when the air pressure regulation valve 4 is in operation, and hence variations in flow rate of the fluid passing through the interior of the air pressure regulation valve 4 may be reduced. The coil spring 47 may be interposed between the pressing portion 455b of the diaphragm holding member 455 and the valve cover 412 instead of being provided between the spring retainer 453 and the valve cover 412.

Subsequently, a method of operation of the air pressure regulation valve 4 will be described in brief. When the valve shaft 44 is positioned upward and the seal member 452 of the valve member 45 is apart from the pressure regulation valve seat 411f, the air pressure regulation valve 4 is in an opened state (illustrated in FIG. 2). In this state, the pressure regulation valve inlet 411d and the pressure regulation valve outlet 411e communicate with each other, and circulation of the fluid such as air therebetween is allowed.

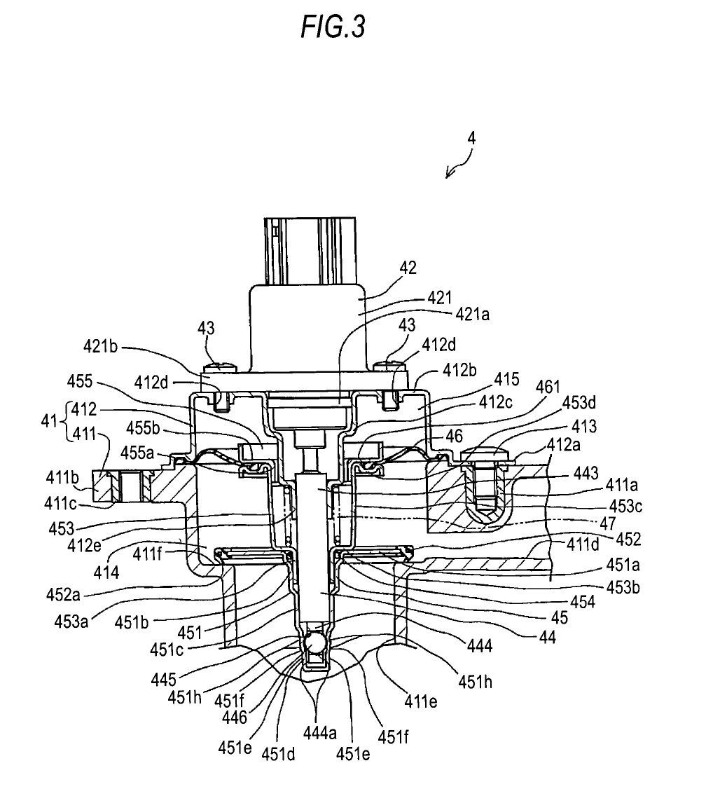

When the stepping motor 422 rotates in one direction by a drive signal from the control apparatus 9, the valve member 45 moves downward in the axial direction together with the valve shaft 44, and the seal member 452 is seated on the pressure regulation valve seat 411f (illustrated in FIG. 3). Accordingly, the air pressure regulation valve 4 is brought into a closed state, communication between the pressure regulation valve inlet 411d and the pressure regulation valve outlet 411e is cut off, and distribution of fluid therebetween is interrupted.

In case where accuracy of parallelism between seal surfaces of the seal member 452 and the pressure regulation valve seat 411f varies when the seal member 452 be seated on the pressure regulation valve seat 411f, the valve member 45 is inclined with respect to the valve shaft 44 while bending the coil spring 47 in conformity to the seal surface of the pressure regulation valve seat 411f, so that the sealing property between the valve member 45 and the pressure regulation valve seat 411f may be secured.

According to the embodiment disclosed here, the valve member 45 is formed by a valve frame 451 including the cylindrical portion 451c in which the valve shaft 44 is inserted in a state in which the radial gap ε is formed with respect to the valve shaft 44, the flat plate portion 451a widening in the radial direction from the cylindrical portion 451c with respect to the valve shaft 44, and the mounting portion 451d continuing at one end thereof from the cylindrical portion 451c, and closed at the other end thereof in a bag shape, and in which the distal end of the valve shaft 44 is housed, and the seal member 452 mounted so as to cover the outer peripheral surface of the flat plate portion 451a and configured to be capable of coming into abutment with the pressure regulation valve seat 411f. The ball hole 445 is provided in the direction orthogonal to the axial center on the coupling portion 444, which is a portion housed in a mounting portion of the valve shaft 44, the rotatable steel ball 446 is arranged in the ball hole 445, and the mounting portion 451d is fixed to the steel ball 446 by caulking or the like. Therefore, when the accuracy in parallelism between the planar direction of the valve frame 451 and the seal surface of the pressure regulation valve seat 411f varies, the valve frame 451 is capable of inclining with respect to the valve shaft 44 until the radial gap is gone by the rotation of the steel ball 446, and hence sealing properties between the valve frame 451 and the pressure regulation valve seat 411f may be secured without improving dimensional accuracies of the component or increasing the size of the air pressure regulation valve 4.

In addition, the gap between the valve shaft 44 and the valve frame 451 in the axial direction does not increase to a distance more than the gap between the steel ball 446 and the ball hole 445. Therefore, reduction of hysteresis in flow rate characteristics of the air pressure regulation valve 4 and improvement of accuracy of flow rate control are achieved.

Since the valve member 45 is regularly inclined about the center of the steel ball 446 or the lower end of a coupling portion 444 and is not inclined more than a predetermined angle controlled by the radial gap ε, generation of vibrations of the valve member 45 and a noise in association therewith are prevented. Therefore, variation in flow rate of the air passing through the interior of the air pressure regulation valve 4 may be reduced and hence improvement of the flow rate control performance of the air pressure regulation valve 4 is achieved.

By caulking the mounting portion 451d and connecting the valve member 45 and the valve shaft 44 after insertion of the coupling portion 444 of the valve shaft 44, the air pressure regulation valve 4 which allows inclination of the valve member 45 with respect to the valve shaft 44 only by the predetermined angle may be formed with a simple configuration and at low cost.

Since the mounting portion 451d in which the distal end portion of the valve shaft 44 is housed is formed into the bag shape, entry of moisture or foreign substances into the mounting portion 451d may be reduced without using a specific seal member and without increasing the size of the air pressure regulation valve 4. In particular, in the vehicle, when the air pressure regulation valve 4 is mounted in the vertical direction as illustrated in FIG. 2, entry of water or the like into the mounting portion 451d from below may be sufficiently prevented.

Since the coupling portion 444 of the valve shaft 44 formed with the ball hole 445 is formed to have a diameter smaller than that of the cylindrical portion 443 inserted into the cylindrical portion 451c, and the steel ball 446 projects from the both end portions of the ball hole 445, the mounting portion 451d may be caulked firmly with respect to the steel ball 446 without causing the inner peripheral surface of the mounting portion 451d to come into abutment with the valve shaft 44.

Since the coupling portion 444 is formed into a width-across-flat shape having the pair of flat surfaces 444a facing each other on the outer peripheral surface thereof, formation of a small diameter portion is easily achieved on the valve shaft 44 housed in the mounting portion 451d.

Since the coupling portion 444 is inserted into the mounting portion 451d in a state in which the steel ball 446 is arranged in the ball hole 445 when mounting the valve member 45 on the valve shaft 44, the air pressure regulation valve 4 having good assembleability is achieved.

Since a inclination mechanism of the valve member 45 is composed of the steel ball 446 and the ball hole 445, the inclination mechanism itself may be reduced in size.

A drive force of the motor assembly 42 is transmitted to the valve member 45 via a contact point between the steel ball 446 and the ball hole 445, a portion which transmits a load is positioned always at a fixed position, and hence further stable sealing performance may be obtained when cutting off the fluid by pressing the valve member 45 against the pressure regulation valve seat 411f.

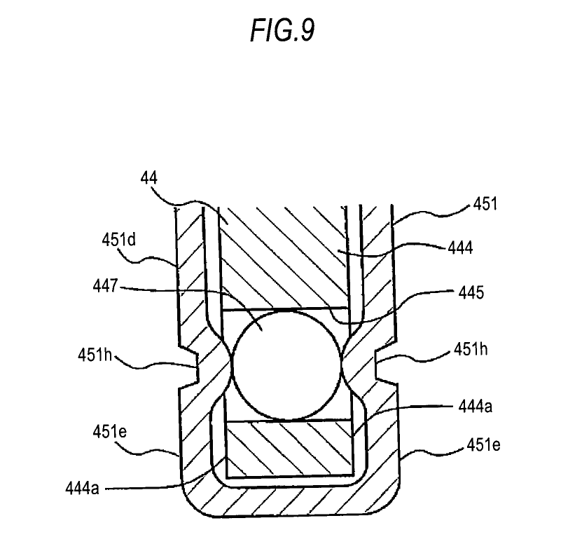

Subsequently, a modification of Embodiment 1 will be described with reference to FIG. 9. In the description, the same reference numerals are used for the same configuration as the air pressure regulation valve 4 of Embodiment 1. In this modification, the ball hole 445 penetrates through the coupling portion 444 in the direction orthogonal to the axial center, and a steel ball 447 (which corresponds to a spherical body) is arranged in the ball hole 445 in the same manner as the case of Embodiment 1. The diameter of the steel ball 447 is slightly smaller than the diameter of the ball hole 445, and the steel ball 447 is rotatable within the ball hole 445, and is housed so as to be movable in the axial direction of the ball hole 445 within the ball hole 445. However, the diameter of the steel ball 447 is set to be smaller than the distance between the flat surfaces 444a (the thickness of the width-across-flat), and the steel ball 447 does not project from both ends of the ball hole 445.

In contrast, the valve frame 451 includes the mounting portion 451d which allows the coupling portion 444 of the valve shaft 44 to be housed therein because a distal end thereof is closed in a bag shape as in the case of Embodiment 1. In the case of this modification, the fitting portions 451f are not formed on both of the fixed walls 451e.

When the valve frame 451 is mounted on the valve shaft 44, the coupling portion 444 is inserted into the mounting portion 451d so that the steel ball 447 is housed in the ball hole 445. Subsequently, the mounting portion 451d is fixed to the steel ball 447 by causing the both fixed walls 451e to enter the ball hole 445 and caulk the steel ball 447, in a state in which the mounting portion 451d is fixed to the steel ball 447. In the case of this modification, the caulked portions 451h are formed one each for each of the both fixed walls 451e.

In this modification as well, it is needless to say that the valve member 45 may be inclined with respect to the valve shaft 44 on the basis of the radial gap ε between the cylindrical portion 451c of the valve frame 451 and the cylindrical portion 443 of the valve shaft 44.

### Embodiment 2

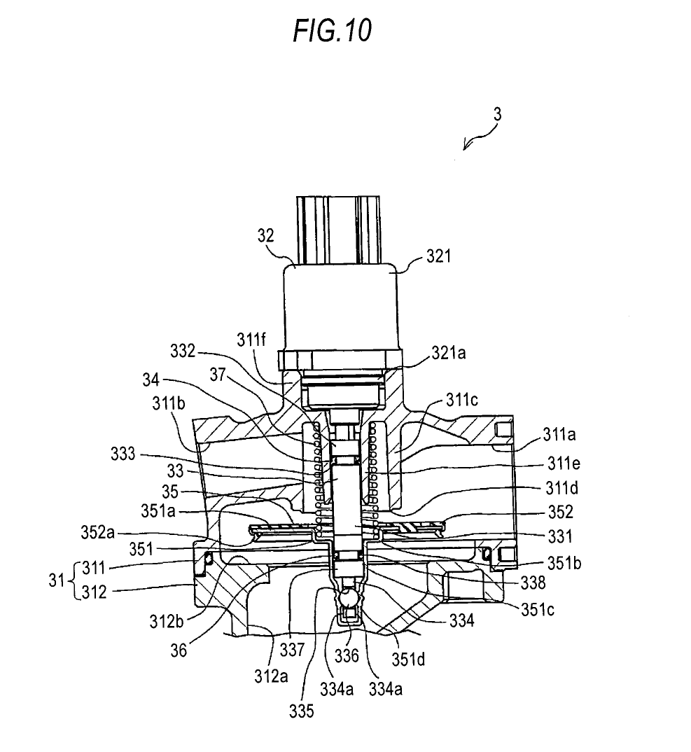

Subsequently, a structure of the three-way valve 3 (which corresponds to a fluid control valve) of Embodiment 2 will be described in detail with reference to FIG. 10 to FIG. 12. Upside and lower side in FIG. 10 are defined as upside and lower side of three-way valve 3, and right side and left side in FIG. 10 correspond to right side and left side of the three-way valve 3, respectively, in the description given below. However, these orientations have no relation to actual mounting directions of the three-way valve 3 in the vehicle.

As illustrated in FIG. 10, the three-way valve 3 is formed by mounting a motor assembly 32 (which corresponds to a drive source) to an outer peripheral surface of a valve housing 31 in the same manner as the air pressure regulation valve 4 of Embodiment 1. The valve housing 31 is formed by fitting a first body 311 and a second body 312 both formed of a synthetic resin material such as polyphenylene sulphide to each other in a liquid-tight manner.

The first body 311 is formed with a three-way valve inlet 311a (which corresponds to an inlet port) opening rightward in FIG. 10. The three-way valve inlet 311a is connected to the inter-cooler 24 via the oxygen system supply pipe 21a described above (illustrated in FIG. 1). The second body 312 is formed with a three-way outlet 312a (which corresponds to an outlet port) opening in the vertical direction with respect to the three-way valve inlet 311a (opening downward in FIG. 10). The three-way outlet 312a is connected to one end of the cathode flow channel 62 of the cell stack 6 via the oxygen system supply pipe 21a described above (illustrated in FIG. 1). The first body 311 is formed with a bypass port 311b opening leftward in FIG. 10. The bypass port 311b is connected to the discharge gas diluter 56 via the bypass conduit line 21c described above (illustrated in FIG. 1).

On an inner peripheral surface of the second body 312, a control valve seat 312b (which corresponds to a valve seat) is formed between the three-way valve inlet 311a and the three-way outlet 312a. The control valve seat 312b is formed into a flat-circular-ring shape.

A cylindrical seating body 311c extends downward from an upper surface of the interior of the first body 311. A lower end of the seating body 311c is formed into a flat shape, and a bypass valve seat 311d positioned between the three-way valve inlet 311a, and the three-way outlet 312a, with respect to the bypass port 311b is formed. From an upper surface of an inner peripheral surface of the first body 311, a cylindrical shaft supporting portion 311e projects so as to be positioned radially inward of the seating body 311c.

In the same manner as the air pressure regulation valve 4 of Embodiment 1, the above-described motor assembly 32 is mounted on an upper surface of the valve housing 31. The motor assembly 32 is fixed to the first body 311 by tightening a plurality of mounting screws, not illustrated, penetrated through a motor case 321 to the first body 311 in a state in which an outer peripheral surface of a mechanism housing 321a of the motor case 321 is fitted to an inner peripheral surface of a motor mounting boss 311f formed on an upper end portion of the first body 311. The mounting screws are loosely fitted into through holes (not illustrated) formed in the motor case 321, and positioning of the motor assembly 32 is achieved by abutment of the outer peripheral surface of the mechanism housing 321a with the inner peripheral surface of the motor mounting boss 311f.

In the same manner as the air pressure regulation valve 4, the stepping motor 422 is fixed to the interior of the motor case 321, a rotary motion of the output shaft 422a of the stepping motor 422 is converted into a translating motion and is transmitted to a valve shaft 33 (which corresponds to a valve shaft). The valve shaft 33 is supported on the inner peripheral surface of the above-described shaft supporting portion 311e so as to be movable in the axial direction thereof.

A column portion 331 extending in the axial direction is formed so as to have a constant diameter at a substantially center portion of the valve shaft 33 in the longitudinal direction. Also, a first land portion 332 having the same diameter as the column portion 331 is provided above the column portion 331, and a first seal groove 333 is formed on the circumference thereof between the column portion 331 and the first land portion 332. A seal packing 34 formed of a synthetic rubber material is fitted in the first seal groove 333. The seal packing 34 delivers a good sealing performance between an outer peripheral surface of the valve shaft 33 and the inner peripheral surface of the shaft supporting portion 311e, so that entry of water, foreign substances or the like in the motor assembly 32 is prevented.

A coupling portions 334 (which corresponds to a portion housed in the mounting portion) formed to have a diameter smaller than that of the cylindrical portion 331 is integrally formed at a distal end portion of the valve shaft 33. In the same manner as the air pressure regulation valve 4, the coupling portion 334 is formed into a width-across-flat shape having a pair of flat surfaces 334a facing each other on an outer peripheral surface thereof.

The coupling portion 334 is formed with a ball hole 335 (which corresponds to a through hole) penetrating in a direction orthogonal to an axial center, and both end portions of the ball hole 335 are opened respectively so as to be orthogonal to the flat surfaces 334a facing to each other. A steel ball 336 (which corresponds to a spherical body) is arranged in the ball hole 335 so as to be rotatable and movable in the axial direction of the ball hole 335. The dimensional relationship among the coupling portion 334, the ball hole 335, and the steel ball 336 is set in the same manner as the air pressure regulation valve 4 of Embodiment 1.

In the same manner as the air pressure regulation valve 4, a valve member 35 is mounted on the coupling portion 334. The valve frame 351 of the valve member 35 includes a flat plate portion 351a extending in a disk shape in the radial direction with respect to an axial center of the valve shaft 33, and the flat plate portion 351a is covered with a seal member 352 formed of synthetic rubber material so as to cover an outer peripheral surface (an upper surface and an outer peripheral edge) thereof.

A seal lip 352a configured to be capable of abutting against the control valve seat 312b formed on the second body 312 by a downward movement of the valve member 35 projects from a lower surface of the seal member 352. As illustrated in FIG. 10, the seal lip 352a is formed radially outward so as to achieve self-sealing by a negative pressure generated by a reaction between hydrogen gas remaining in the cell stack 6 and oxygen. Also, an upper surface of the seal member 352 is formed to be flat, and may be brought into abutment with the bypass valve seat 311d formed on the first body 311 by an upward movement of the valve member 35.

The valve frame 351 is formed with a depressed portion 351b depressed toward a distal end of the valve shaft 33 (a configuration including the flat plate portion 351a and the depressed portion 351b corresponds to an extending portion) is formed at a radially center of the flat plate portion 351a. The valve frame 351 includes a cylindrical portion 351c (which corresponds to a cylindrical portion) continuing to an inner peripheral end of the depressed portion 351b. The cylindrical portion 351c extends in the vertical direction with respect to the flat plate portion 351a, and the cylindrical portion 331 of the valve shaft 33 is inserted therein.

In addition, the valve frame 351 includes a mounting portion 351d formed so as to be continuous with the other end of the cylindrical portion 351c and accepts the coupling portion 334 of the valve shaft 33 in the same manner as the air pressure regulation valve 4. The mounting portion 351d is caulked with respect to the steel ball 336 projecting from the ball hole 335, and is fixed to the steel ball 336 so as not to be decoupled therefrom.

In FIG. 10, reference numerals in the configuration similar to the air pressure regulation valve 4 in the configuration formed on the mounting portion 351d for mounting the valve member 35 on the valve shaft 33 are intentionally omitted.

In the same manner as the air pressure regulation valve 4, in a state in which the valve frame 351 is mounted on the valve shaft 33, the radial gap ε with respect to the axial center of the valve shaft 33 is formed on the entire circumference between the inner peripheral surface of the cylindrical portion 351c and the outer peripheral surface of the column portion 331 of the inserted valve shaft 33.

In the valve shaft 33, a second land portion 337 having the same diameter as the column portion 331 is provided above the coupling portion 334 described above, and a second seal groove 338 is formed on the circumference thereof between a lower end of the column portion 331 and the second land portion 337. A ring-shaped shaft seal 36 (which corresponds to a ring-shaped seal member) formed of a synthetic resin member is mounted in the second seal groove 338. The shaft seal 36 delivers a sealing performance between the outer peripheral surface of the valve shaft 33 and the inner peripheral surface of the cylindrical portion 351c of the valve frame 351, and entry of water, foreign substances or the like into the cylindrical portion 351c and the mounting portion 351d of the valve frame 351 is prevented.

The shaft seal 36 is provided resiliently between the outer peripheral surface of the valve shaft 33 and the inner peripheral surface of the cylindrical portion 351c of the valve frame 351, and a predetermined sliding resistance is generated therebetween. Therefore, the valve member 35 is held at the axial center of the valve shaft 33 (centering) by the shaft seal 36 so that vibrations of the valve member 35 with respect to the valve shaft 33 and noise in association therewith may be reduced, and reduction of variations in flow rate of fluid passing through the interior of the three-way valve 3 is achieved.

A valve spring 37 is interposed between the depressed portion 351b of the valve frame 351 and the upper surface of the interior of the first body 311. An inner peripheral surface of the valve spring 37 is secured by fitted to an outer peripheral surface of the shaft supporting portion 311e described above by being fitted thereto. The valve spring 37 is mounted resiliently between the valve frame 351 and the first body 311, and urges the valve member 35 toward the distal end of the valve shaft 33. The valve member 35 is held without being displaced form the axial center of the valve shaft 33 (centering) and without being inclined about the axial center of the valve shaft 33 by an urging force of the valve spring 37.

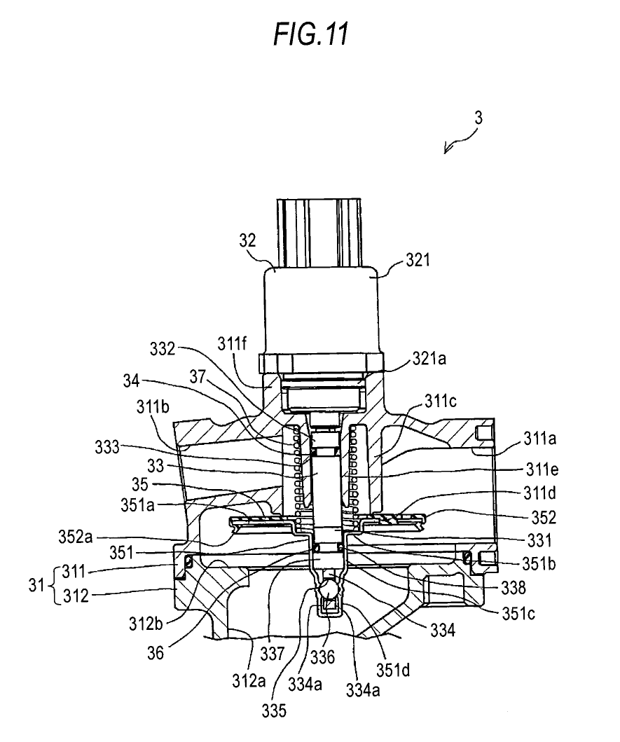

Subsequently, a method of operation of the three-way valve 3 will be described in brief. When the valve shaft 33 is positioned on an upper side, the upper surface of the seal member 352 of the valve member 35 is seated on the bypass valve seat 311d, and is apart from the control valve seat 312b (illustrated in FIG. 11). At this time, the three-way valve inlet 311a and the three-way outlet 312a are in communication with each other, and hence mutual distribution of fluid such as air is allowed. In contrast, the communication between the three-way valve inlet 311a and the three-way outlet 312a with respect to the bypass port 311b is cut out, so that the distribution of the fluid therebetween is interrupted.

In a case where accuracy of parallelism between seal surfaces of the seal member 352 and the bypass valve seat 311d varies when the seal member 352 is seated on the bypass valve seat 311d, the valve member 35 is inclined with respect to the valve shaft 33 while bending the valve spring 37 in conformity to the seal surface of the bypass valve seat 311d by the rotation of the steel ball 336, so that the sealing property between the valve member 35 and the bypass valve seat 311d may be secured.

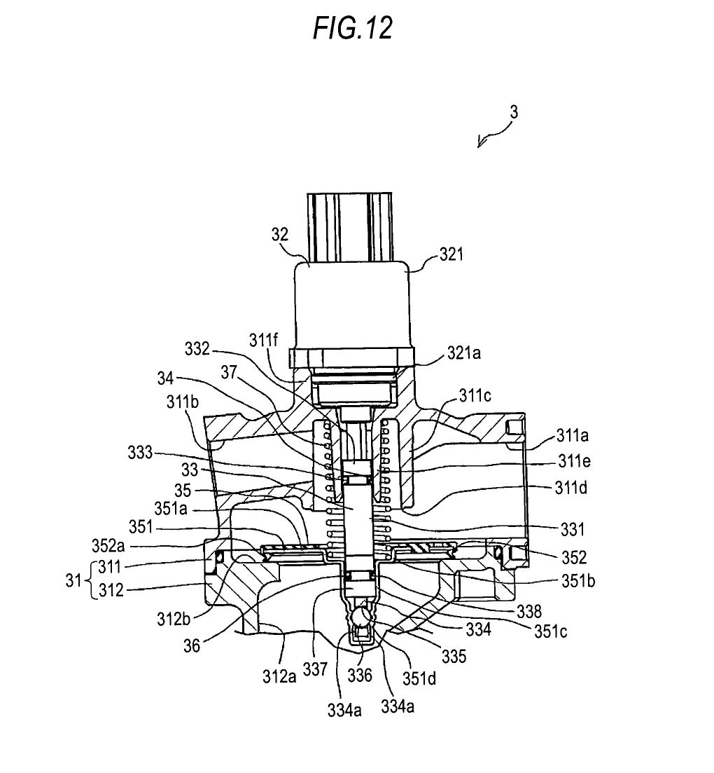

When the stepping motor rotates in one direction by a drive signal from the control apparatus 9, the valve member 35 moves downward in the axial direction together with the valve shaft 33, and the upper surface of the seal member 352 moves away from the bypass valve seat 311d and the seal lip 352a is seated on the control valve seat 312b (illustrated in FIG. 12). At this time, the three-way valve inlet 311a and the bypass port 311b are in communication with each other, and hence mutual distribution of fluid such as air is allowed. In contrast, the communication between the three-way valve inlet 311a and the bypass port 311b with respect to three-way outlet 312a is cut off, so that the distribution of the fluid therebetween is interrupted.

In case where accuracy of parallelism between seal surfaces of the seal member 352 and the control valve seat 312b varies when the seal member 352 is seated on the control valve seat 312b by the rotation of the steel ball 336, the valve member 35 is inclined with respect to the valve shaft 33 while bending the valve spring 37 in conformity to the seal surface of the control valve seat 312b, so that the sealing property between the valve member 35 and the control valve seat 312b may be secured.

In the three-way valve 3, the valve member 35 is capable of controlling the rates of flow of the fluid supplied from the three-way valve inlet 311a split to the three-way outlet 312a and the bypass port 311b respectively on the basis of the cross-sectional area of a passage where the fluid passes by taking an arbitrary position between the control valve seat 312b and the bypass valve seat 311d (illustrated in FIG. 10).

According to this embodiment, since the ring-shaped shaft seal 36 is interposed between the outer peripheral surface of the valve shaft 33 and the inner peripheral surface of the cylindrical portion 351c, the sealing property of the mounting portion 351d is further improved, and hence the probability of entry of moisture, foreign substances or the like into the mounting portion 351d may further be reduced.

### Other Embodiments

The invention is not limited to the embodiments described above, and a modification or an extension as described below may be made.

By resiliently providing the seal member between an inner peripheral surface of the valve frame 451 and the outer peripheral surface of the valve shaft 44 of the air pressure regulation valve 4, the valve member 45 may be held at the axial center of the valve shaft 44 (centering) and vibrations of the valve member 45 with respect to the valve shaft 44 and a noise in association therewith may be reduced by using a sliding resistance generated therebetween.

Also, in the modification of Embodiment 1, the coupling portion 444 does not have to be reduced in diameter with respect to the cylindrical portion 443, and may be a complete circle in cross section having the same diameter as that of the cylindrical portion 443.

In the valve members 35 and 45 illustrated in FIG. 2 and FIG. 10, a configuration in which the flat plate portions 351a and 451a are formed below the cylindrical portions 351c and 451c and the mounting portions 351d and 451d are formed below the flat plate portions 351a and 451a so as to continue from the flat plate portions 351a and 451a is also applicable.

### Embodiment 3

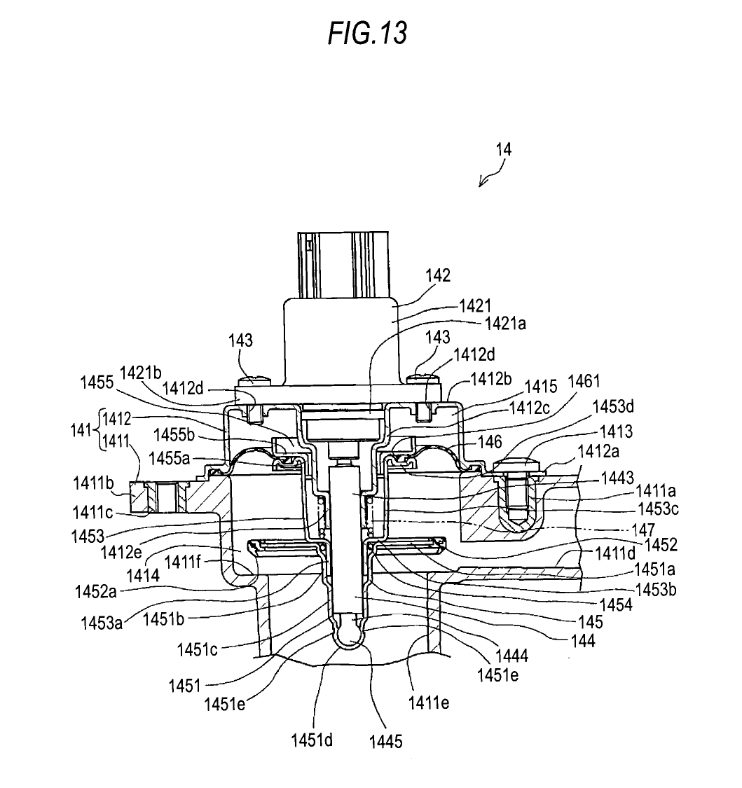

Referring now to FIG. 1, FIG. 13 to FIG. 21, the air pressure regulation valve 4 according to Embodiment 3 disclosed here will be described.

As illustrated in FIG. 1, the air pressure regulation valve 4 (which corresponds to a fluid control valve) according to this embodiment is applied to the oxygen system 2 of the fuel cell system 1 mounted on the vehicle. However, the invention is not limited thereto, and the air pressure regulation valve 4 may be used widely as the vehicle fluid control valve such as the fuel supply system or the hydraulic brake system, and may be applied as the fluid control valve for the household appliances or the general industrial machines.

Upside and lower side in FIG. 13 are defined as upside and lower side of the air pressure regulation valve 4, and right side and left side in FIG. 13 correspond to right side and left side of the air pressure regulation valve 4, respectively, in the description. However, these orientations have no relation to actual mounting directions of the air pressure regulation valve 4 in the vehicle.

As illustrated in FIG. 1, the fuel cell system 1 includes the oxygen system 2, the fuel system 5, the cell stack 6, the power system 7, the cooling system 8, and the control apparatus 9. Since the configurations of the oxygen system 2, the fuel system 5, the cell stack 6, the power system 7, the cooling system 8, and the control apparatus 9 and the operation of the fuel cell system 1 are the same as described above, description will be omitted.

Subsequently, the structure of an air pressure regulation valve 14 will be described in detail. As illustrated in FIG. 13, the air pressure regulation valve 14 is formed by mounting a motor assembly 142 (which corresponds to a drive source) on an outer peripheral surface of a valve housing 141. The valve housing 141 is formed by joining a valve body 1411 formed of a synthetic resin material and a valve cover 1412 formed integrally of a metallic plate to each other. In this embodiment, the motor assembly 142 employing an electric motor is used as a drive source. However, a solenoid actuator or an actuator driven by a gas pressure may be used.

A cover mounting sleeve 1411a formed of a metal for mounting the valve cover 1412 is inserted into the valve body 1411. A metal sleeve 1411c for mounting the air pressure regulation valve 14 to the vehicle is inserted into a flange portion 1411b of the valve body 1411. A female screw thread is formed on each of inner peripheral surfaces of the cover mounting sleeve 1411a and the metal sleeve 1411c.

The valve body 1411 is formed with a pressure regulation valve inlet 1411d (which corresponds to an inlet port) opening rightward in FIG. 13. The pressure regulation valve inlet 1411d is connected to the other end of the cathode flow channel 62 of the cell stack 6 via the oxygen system discharging pipe 21b described above (illustrated in FIG. 1). The valve body 1411 is formed with a pressure regulation valve outlet 1411e (which corresponds to an outlet port) opening in the vertical direction with respect to the pressure regulation valve inlet 1411d (opening downward in FIG. 13). The pressure regulation valve outlet 1411e is connected to the discharge gas diluter 56 via the oxygen system discharging pipe 21b described above.

On an inner peripheral surface of the valve body 1411, a pressure regulation valve seat 1411f (which corresponds to a valve seat) is formed. The pressure regulation valve seat 1411f is formed into a flat-circular-ring shape between the pressure regulation valve inlet 1411d and the pressure regulation valve outlet 1411e.

The valve cover 1412 is mounted on an upper end surface of the valve body 1411 by tightening a mounting bolt 1413 penetrated therethrough into the cover mounting sleeve 1411a. The valve cover 1412 includes a mounting surface 1412a with respect to the valve body 1411, a motor mounting portion 1412b projecting upward from the mounting surface 1412a, and a shaft housings 1412c stepwise lowered at a center portion of the motor mounting portion 1412b and having an opened lower end portion. A plurality of female screw holes 1412d are provided on an upper surface of the motor mounting portion 1412b. The valve cover 1412 includes the above-described mounting surface 1412a, the motor mounting portion 1412b, and the shaft housing 1412c formed integrally by press-molding a metal plate.

The above-described motor assembly 142 is mounted on the upper surface of the motor mounting portion 1412b. The motor assembly 142 is fixed to the valve cover 1412 by tightening a plurality of mounting screws 143 penetrated through a mounting flanges 1421b into the female screw holes 1412d of the motor mounting portion 1412b in a state in which an outer peripheral surface of a mechanism housing 1421a of a motor case 1421 fitted into an inner peripheral surface of the shaft housing 1412c. The mounting screws 143 is loosely fitted into through holes (not illustrated) formed in the mounting flanges 1421b, and positioning of the valve cover 1412 is achieved by abutment of the inner peripheral surface of the shaft housing 1412c with the outer peripheral surface of the mechanism storage 1421a.

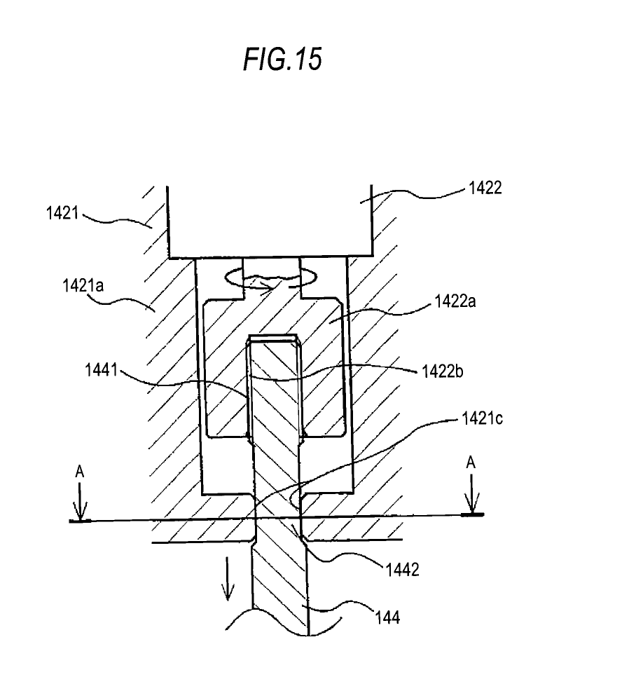

As illustrated in FIG. 15, a stepping motor 1422 is fixed to an inner wall of the motor case 1421. A distal end of an output shaft 1422a of the stepping motor 1422 has a cylindrical shape, and a drive hole 1422b is formed at an axial center thereof. A female screw thread having a predetermined length is formed on an inner peripheral surface of the drive hole 1422b, and engages a male screw thread portion 1441 formed on an outer peripheral surface of an end portion of the valve shaft 144 (which corresponds to a valve shaft).

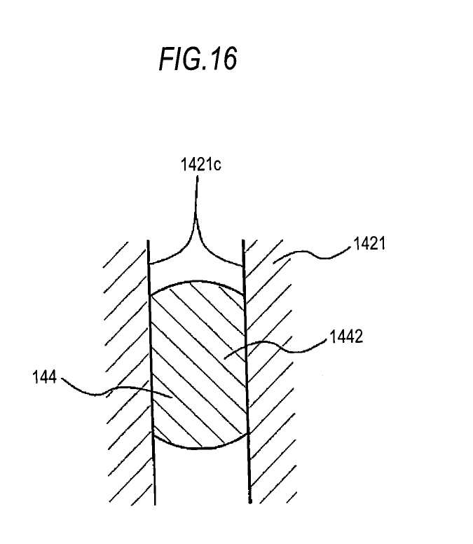

The valve shaft 144 is formed of a metallic material such as stainless, and a width-across-flat portion 1442 is formed below the male screw thread portion 1441. The width-across-flat portion 1442 engages a pair of opposed surface 1421c formed at a lower end portion of the motor case 1421, whereby the valve shaft 144 is prohibited from rotating with respect to the motor case 1421 (illustrated in FIG. 16). Therefore, when the output shaft 1422a of the stepping motor 1422 rotates in one direction, the valve shaft 144 is moved downward in the axial direction in the valve housing 141, and when the output shaft 1422a rotates in the opposite direction, the valve shaft 144 is moved upward.

Preferably, the male screw thread portion 1441 of the valve shaft 144 described above and the female screw thread on the output shaft 1422a are each formed of a trapezoidal screw, and backward efficiency between the valve shaft 144 and the output shaft 1422a is set to approximately zero. Accordingly, transmission of operation between the valve shaft 144 and the output shaft 1422a is formed irreversibly, and when a returning load acts from the valve shaft 144 toward the output shaft 1422a in a state in which the air pressure regulation valve 14 is closed, the output shaft 1422a does not rotate in the direction of opening the valve, and hence the air pressure regulation valve 14 is prevented from opening accidentally.

As illustrated in FIG. 13, a column portion 1443 projecting from the motor case 1421 and extending from the motor case 1421 in the axial direction so as to have a constant diameter is formed below the width-across-flat portion 1442 of the valve shaft 144. An outer peripheral surface of the column portion 1443 is supported by a shaft retainer portion 1412e formed at a lower end of the shaft housing 1412c of the valve cover 1412 so as to be movable in the axial direction. The outer peripheral surface of the cylindrical portion 1443 and the shaft retainer portion 1412e in abutment with each other are plated by electroless nickel plating or the like to improve abrasion resistance of a sliding surface therebetween.

In addition, a substantially spherical-shaped supporting member 1445 is integrally formed at a distal end portion of the column portion 1443 via a small diameter bridge portion 1444. A valve member 145 is mounted on the supporting member 1445 formed at a distal end portion of the valve shaft 144 so as to extend in the radial direction with respect to an axial center of the valve shaft 144.

A valve frame 1451 of the valve member 145 is formed of a metal plate such as stainless by press forming. The valve frame 1451 includes a flat plate portion 1451a extending in a disk shape in the radial direction with respect to the axial center of the valve shaft 144, and a seal member 1452 is secured to the flat plate portion 1451a so as to cover an outer peripheral edge thereof.

The seal member 1452 is formed of a synthetic rubber material having heat resistance such as SBR (styrene-butadiene rubber) or EPDM (ethylene-propylene-diene copolymer). On a lower surface of the seal member 1452, a seal lip 1452a configured to be capable of abutting against the pressure regulation valve seat 1411f formed on the valve body 1411 by a downward movement of the valve member 145. As illustrated in FIG. 13, the seal lip 1452a is formed radially inward (toward the pressure regulation valve outlet 1411e) so as to achieve self-sealing by a reaction between hydrogen gas remaining in the cell stack 6 and oxygen or a negative pressure generated by condensation of residual moisture caused by decrease in temperature of the cell stack 6 or the like when power generation is stopped.

The valve frame 1451 is formed with a continuous step portion 1451b (a configuration including the flat plate portion 1451a and the step portion 1451b corresponds to an extending portion) continuously from a radially center portion of the flat plate portion 1451a. The step portion 1451b extends in the axial direction of the valve shaft 144, and steps in the radial direction are formed at two locations so as to be aligned in the axial direction.

The valve frame 1451 includes a cylindrical portion 1451c (which corresponds to a cylindrical portion) continuing at one end thereof to the step portion 1451b. The cylindrical portion 1451c extends in the vertical direction with respect to the flat plate portion 1451a, and the column portion 1443 of the valve shaft 144 is inserted therein. In addition, the valve frame 1451 includes a mounting portion 1451d which allows the curved surface of the supporting member 1445 of the valve shaft 144 to be received therein by being formed so as to be continuous from the other end of the cylindrical portion 1451c and closed at a distal end thereof in a bag shape by a semispherical curved surface.

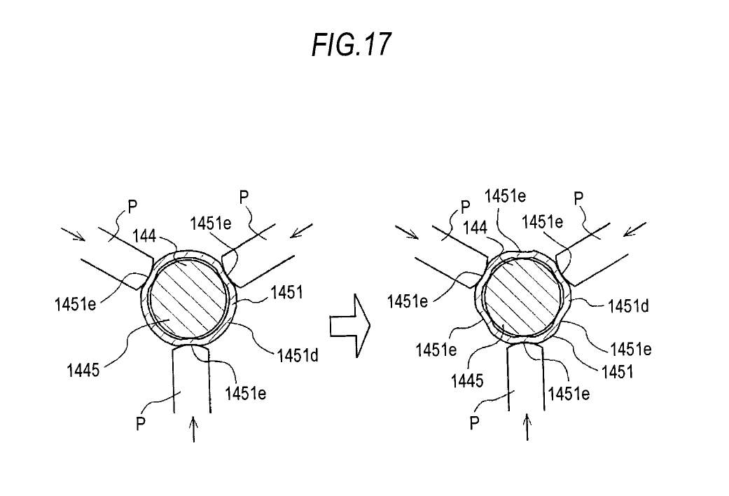

The mounting portion 1451d is mounted on the supporting member 1445 by caulking. As illustrated in FIG. 17, after the supporting member 1445 of the valve shaft 144 is inserted into the mounting portion 1451d as a first step, three punches P arranged so as to be equiangular with respect to each other on the circumference are activated radially inward at the same time, so that three positions on an outer peripheral surface of the mounting portion 1451d are caulked uniformly toward the supporting member 1445. Accordingly, the caulked portions 1451e are formed at three positions on the outer peripheral surface of the mounting portion 1451d.

Subsequently, after the valve flame 1451 is rotated by 60° in a state in which the punches P are returned, caulking in the same manner is performed by the above-described punches P. Accordingly, the mounting portion 1451d is uniformly caulked at six of the caulked portions 1451e on the circumference with respect to the supporting member 1445 of the valve shaft 144, and is connected to the supporting member 1445 so as not to be decoupled therefrom.

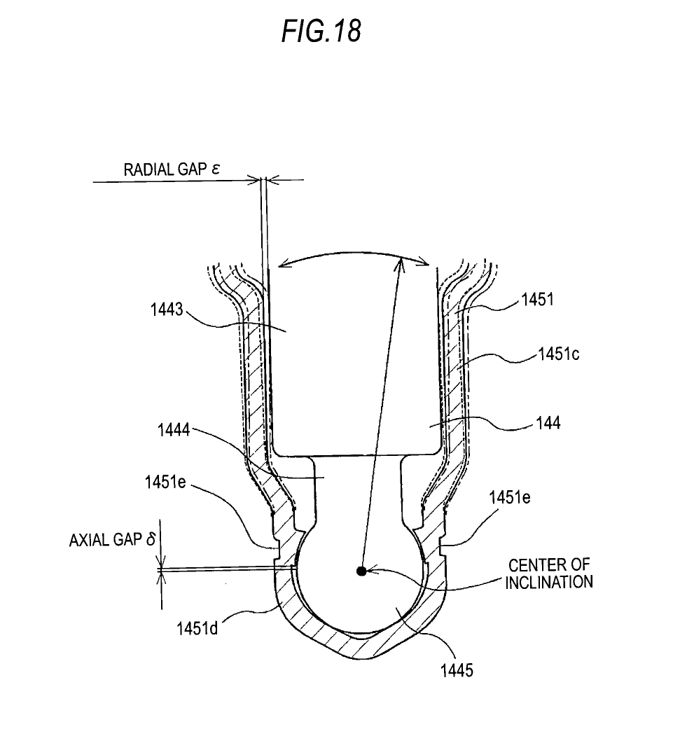

As illustrated in FIG. 18, the valve flame 1451 is formed with a gap δ in the axial direction of the valve shaft 144 between an outer peripheral surface of the supporting member 1445 and the respective caulked portions 1451e of the mounting portion 1451d in state of being mounted on the valve shaft 144. The gap δ in the axial direction is small and is formed so as to allow the valve member 145 to incline with respect to the valve shaft 144 as described later. The gap δ in the axial direction is preferably formed to be as small as possible as long as the valve member 145 can incline, and may be substantially zero.

In a state in which the valve frame 1451 is mounted on the valve shaft 144, the gap ε in the radial direction with respect to the axial center of the valve shaft 144 (hereinafter, referred to as the radial gap ε) is formed between an inner peripheral surface of the cylindrical portion 1451c and the outer peripheral surface of the column portion 1443 of the inserted valve shaft 144. As illustrated in FIG. 18, the radial gap ε is formed over an entire circumference between the inner peripheral surface of the cylindrical portion 1451c and the outer peripheral surface of the column portion 1443. The valve member 145 mounted on the valve shaft 144 is inclined with a substantially center point of the spherical supporting member 1445 as a center of inclination, and the radial gap ε controls the angle of inclination (indicated by a broken line and a double-dashed chain line in FIG. 18).

The magnitude of the radial gap ε is set on the basis of the diameter of the seal portion with respect to the pressure regulation valve seat 1411f of the seal member 1452 so that the valve member 145 is inclined by a predetermined amount with respect to the valve shaft 144 about the supporting member 1445 of the distal end portion of the valve shaft 144 in conformity to the pressure regulation valve seat 1411f so as to achieve sealing when the valve member 145 is seated on the pressure regulation valve seat 1411f of the valve body 1411.

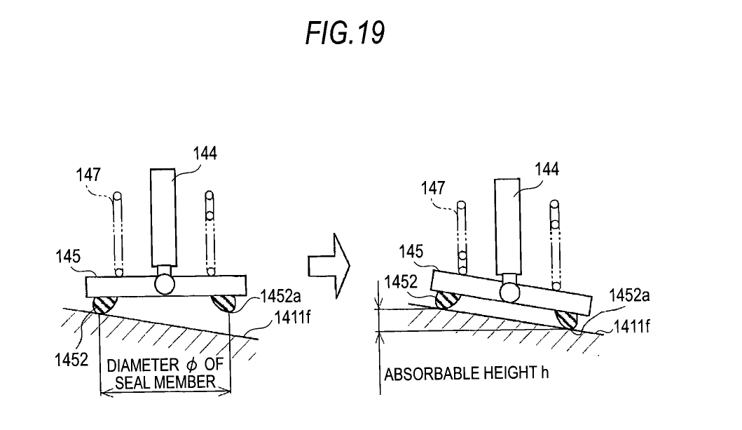

In other words, as illustrated in FIG. 19, when accuracy of parallelism between the valve member 145 and the pressure regulation valve seat 1411f varies, a height (level difference) h to be absorbed by the valve member 145 corresponds to a diameter φ of the seal lip 1452a of the seal member 1452.

Normally, the diameter φ of the seal lip 1452a is functionally set on the basis of the amount of fluid to be passed through the air pressure regulation valve 14. Variations in accuracy of parallelism between the valve member 145 and the pressure regulation valve seat 1411f are determined by accuracies of the valve housing 141 and the motor assembly 142 in manufacture.

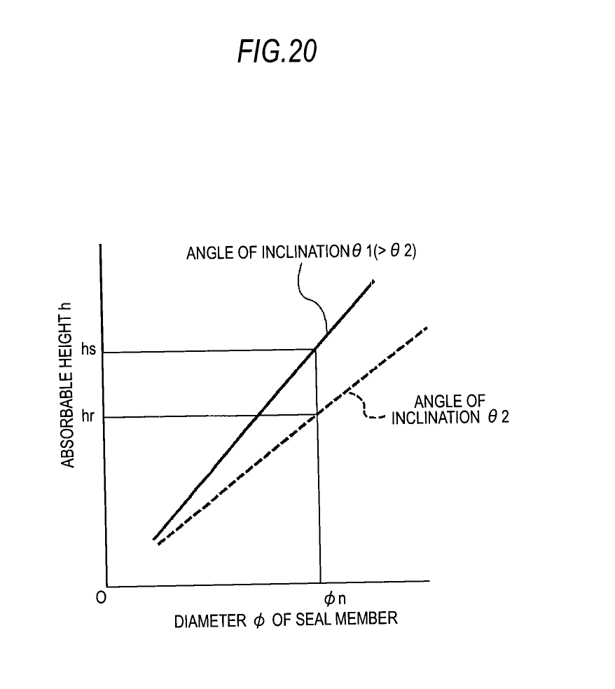

It is assumed here that the diameter φ of the seal lip 1452a required by the air pressure regulation valve 14 in terms of its function is φn, the maximum level difference h of the pressure regulation valve seat 1411f to be considered on the basis of φn and the accuracy in manufacture is hr, and a height of absorption of the valve member 145 in a case where the diameter φ of the seal lip 1452a is φn is hs. In this case, in the graph shown in FIG. 20, an angle equal to or larger than an angle θ2 of a straight line connecting a point to specify the diameter φn of the seal lip 1452a and the maximum level difference hr of the pressure regulation valve seat 1411f and an original point corresponds to an angle θ1 by which the valve member 145 must be inclined with respect to the axial direction of the valve shaft 144 in order to secure the sealing function. Consequently, the radial gap ε between the cylindrical portion 1451c of the valve flame 1451 and the column portion 1443 of the valve shaft 144 is set to a value by which the valve member 145 may be inclined with respect to the axial direction of the valve shaft 144 by θ1 (equal to or larger than θ2).

Returning back to FIG. 13, a spring retainer 1453 is fixed to an inner peripheral surface of the step portion 1451b of the valve frame 1451 by being press-fitted thereto from above. The spring retainer 1453 is formed by squeezing a metal plate by a press process. The spring retainer 1453 includes a cylindrical fixing portion 1453a positioned between a step formed below the step portion 1451b and the column portion 1443, and a shoulder portion 1453b widening radially outward from the fixing portion 1453a.

The fixing portion 1453a of the spring retainer 1453 is press-fitted to the inner peripheral surface of the step portion 1451b of the valve frame 1451 until the shoulder portion 1453b comes into abutment with an upper surface of the flat plate portion 1451a of the valve frame 1451. The fixing portion 1453a press-fitted into the step portion 1451b has a gap from the outer peripheral surface of the column portion 1443 of the valve shaft 144, and hence inclination of the valve member 145 with respect to the valve shaft 144 cannot be hindered.

An O-ring 1454 as a seal member is interposed between a step formed above the step portion 1451b and the fixing portion 1453a. The O-ring 1454 delivers a sealing function between the valve frame 1451 and the fixing portion 1453a, and prevents entry of moisture or foreign substances entering into the air pressure regulation valve 14 to an air chamber 1415 divided by the mounting portion 1451d of the valve frame 1451 or a diaphragm 146, described later.

Furthermore, the spring retainer 1453 is provided with a coupling portion 1453c extending upward from the shoulder portion 1453b and a tightening portion 1453d widening radially outward from the coupling portion 1453c.

A diaphragm holding member 1455 includes an engaging portion 1455a extending in the axial direction of the valve shaft 144 at a radially inner end, and a pressing portion 1455b extends radially from an upper end of the engaging portion 1455a. The engaging portion 1455a is press-fitted to an inner peripheral surface of the coupling portion 1453c until a lower surface of the pressing portion 1455b comes into abutment with an upper end of the coupling portion 1453c of the spring retainer 1453, whereby the spring retainer 1453 and the diaphragm holding member 1455 are integrated.

Between the tightening portion 1453d of the spring retainer 1453 and the pressing portion 1455b of the diaphragm holding member 1455, an inner peripheral edge of the diaphragm 146 is fixed. The diaphragm 146 is formed integrally of a synthetic rubber material, and a mounting hole 1461 penetrating therethrough from the front to the back is formed at a substantially center portion. A peripheral edge of the mounting hole 1461 is pinched by the tightening portion 1453d and the pressing portion 1455b in the vertical direction, and is fixed therebetween in a liquid-tight manner.

An outer peripheral edge of the diaphragm 146 is pinched between an upper end surface of the above-described valve body 1411 and a lower end of the motor mounting portion 1412b of the valve cover 1412, and is fixed in a liquid-tight manner. In this manner, by the diaphragm 146 mounted on an inner peripheral surface of the valve housing 141 and the valve member 145, the interior of the valve housing 141 is divided into two parts by the diaphragm 146 and the valve member 145. In other words, the interior of the valve housing 141 is formed with a fluid chamber 1414 including the pressure regulation valve inlet 1411d, the pressure regulation valve outlet 1411e, and the pressure regulation valve seat 1411f and configured to allow passage of supplied fluid, and the air chamber 1415 prevented from entry of fluid or the like and filled with air. The air chamber 1415 communicates with outside air via a ventilation hole, not illustrated, provided in the valve cover 1412.

A coil spring 147 (which corresponds to a coil spring) is interposed between the shoulder portion 1453b of the spring retainer 1453 and a step portion of the shaft housing 1412c of the valve cover 1412 so as to surround the valve shaft 144 in the circumferential direction. The coil spring 147 is mounted resiliently between the spring retainer 1453 and the valve cover 1412, and urges the valve member 145 toward a distal end of the valve shaft 144. By an urging force of the coil spring 147, when the air pressure regulation valve 14 is opened, the caulked portions 1451e of the valve flame 1451 comes into abutment with the supporting member 1445 of the valve shaft 144.

When fluid such as air having a predetermined pressure is supplied from the pressure regulation valve inlet 1411d into the valve housing 141, the above-described diaphragm 146 receives a pressure from the fluid, and an upper portion of the valve member 145 is pulled uniformly along the circumference thereof by the diaphragm 146 and is held without being displaced from the axial center of the valve shaft 144 (centering) and inclining with respect to the axial center of the valve shaft 144.

A lower portion of the valve member 145 is also held by an urging force of the coil spring 147 described above toward the distal end of the valve shaft 144 without being displaced from the axial center of the valve shaft 144 (centering) and inclining with respect to the axial center of the valve shaft 144. Also, the gap δ in the axial direction between the valve flame 1451 and the valve shaft 144 in a state in which the air pressure regulation valve 14 is opened is gone by the urging force of the coil spring 147, so that generation of vibrations of the valve member 145 and a noise in association therewith may be prevented.

By holding forces of the diaphragm 146 and the coil spring 147 as described above, generation of the vibrations of the valve member 145 and the noise in association therewith are prevented in a state in which the air pressure regulation valve 14 is operated, and hence variations in flow rate of the fluid passing through the interior of the air pressure regulation valve 14 may be reduced. The coil spring 147 may be interposed between the pressing portion 1455b of the diaphragm holding member 1455 and the valve cover 1412 instead of being provided between the spring retainer 1453 and the valve cover 1412.

Subsequently, a method of operation of the air pressure regulation valve 14 will be described in brief. When the valve shaft 144 is positioned upward and the seal member 1452 of the valve member 145 is apart from the pressure regulation valve seat 1411f, the air pressure regulation valve 14 is in an opened state (illustrated in FIG. 13). In this state, the pressure regulation valve inlet 1411d and the pressure regulation valve outlet 1411e communicate with each other, and distribution of the fluid such as air therebetween is allowed. At this time, the caulked portions 1451e of the valve flame 1451 are maintained in a state of being in abutment with the supporting member 1445 of the valve shaft 144 under the receipt of the urging force of the coil spring 147.

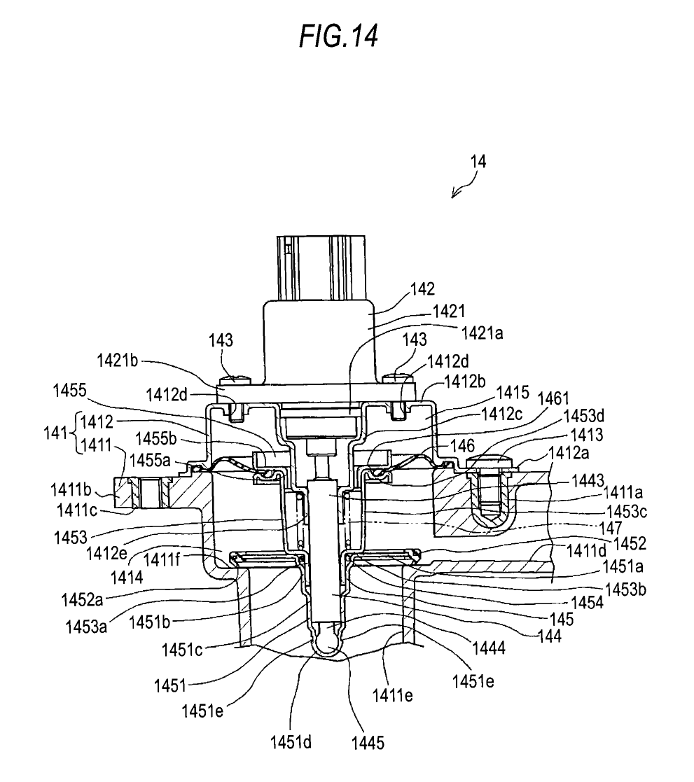

When the stepping motor 1422 rotates in one direction by a drive signal from the control apparatus 9, the valve member 145 moves downward in the axial direction together with the valve shaft 144, and the seal member 1452 is seated on the pressure regulation valve seat 1411f (illustrated in FIG. 14). Accordingly, the air pressure regulation valve 14 is brought into a closed state, communication between the pressure regulation valve inlet 1411d and the pressure regulation valve outlet 1411e is cut off, and distribution of fluid therebetween is interrupted. In this state, the coil spring 147 is compressed and presses the valve member 145 against the pressure regulation valve seat 1411f by a predetermined urging force.

In a case where accuracy of parallelism between seal surfaces of the seal member 1452 and the pressure regulation valve seat 1411f varies when the seal member 1452 is seated on the pressure regulation valve seat 1411f, the valve member 145 is inclined with respect to the valve shaft 144 about the supporting member 1445 of the valve shaft 144 while bending the coil spring 147 in conformity to the seal surface of the pressure regulation valve seat 1411f, so that the sealing property between the valve member 145 and the pressure regulation valve seat 1411f may be secured.

According to this embodiment, the valve member 145 includes the valve flame 1451, the valve flame 1451 includes the cylindrical portion 1451c extending in the axial direction of the valve shaft 144 and allows insertion of the valve shaft 144, the flat plate portion 1451a spreading in the radial direction with respect to the valve shaft 144 from the cylindrical portion 1451c and includes the seal member 1452 mounted thereon, and the mounting portion 1451d continuing from the cylindrical portion 1451c and closed in a bag shape at one end thereof configured to receive the curved surface formed at the distal end portion of the valve shaft 144. The valve shaft 144 has the radial gap ε from the cylindrical portion 1451c of the valve flame 1451, is connected to the mounting portion 1451d so as not to be decoupled therefrom and has the gap δ in the axial direction. Therefore, when accuracy of parallelism between the planar direction of the valve member 145 and the seal surface of the pressure regulation valve seat 1411f, the valve member 145 is capable of inclining until the radial gap ε with respect to the valve shaft 144 is gone about the supporting member 1445 of the valve shaft 144, and the sealing property between the valve member 145 and the pressure regulation valve seat 1411f may be secured without improving dimensional accuracies of components or without increasing the size of the air pressure regulation valve 14.

Since the valve member 145 is regularly inclined about the supporting member 1445 of the valve shaft 144 and is not inclined more than a predetermined angle controlled by the radial gap ε, generation of vibrations of the valve member 145 and a noise in association therewith are prevented. Therefore, variation in flow rate of the air passing through the interior of the air pressure regulation valve 14 may be reduced and hence improvement of the flow rate control performance of the air pressure regulation valve 14 is achieved.

By caulking the mounting portion 1451d and connecting the valve member 145 and the valve shaft 144 after insertion of the supporting member 1445 of the valve shaft 144, the air pressure regulation valve 14 which allows inclination of the valve member 145 with respect to the valve shaft 144 only by the predetermined angle may be formed with a simple configuration and at low cost.

By forming the gap δ in the axial direction between the valve member 145 and the valve shaft 144 by caulking the mounting portion 1451d, the gap δ in the axial direction may be minimized.

Since the size of the radial gap ε between the valve shaft 144 and the cylindrical portion 1451c is set on the basis of the diameter φ of the seal lip 1452a of the seal member 1452, when the valve member 145 is seated on the pressure regulation valve seat 1411f, the level difference h of the pressure regulation valve seat 1411f caused by the parallelism between the planer direction of the valve member 145 and the seal surface of the pressure regulation valve seat 1411f and the diameter φ of the seal lip 1452a may reliably absorbed.

Since the coil spring 147 provided so as to surround the valve shaft 144 in the circumferential direction and configured to urge the valve member 145 toward the distal end of the valve shaft 144 is interposed between the valve member 145 and the valve housing 141, the valve member 145 may be urged uniformly toward the distal end of the valve shaft 144 in the circumference thereof, and vibrations of the valve member 145 with respect to the valve shaft 144 and a noise in association therewith are further reduced, so that variations in flow rate of the fluid may further be inhibited.

Since the interior of the valve housing 141 is divided by the diaphragm 146 and the valve member 145 to form the fluid chamber 1414 including the pressure regulation valve inlet 1411d, the pressure regulation valve outlet 1411e and the pressure regulation valve seat 1411f and allowing passage of fluid such as air and the air chamber 1415 configured to prevent entry of the fluid, if fluid associated with a pressure enters the fluid chamber 1414, a strain is generated in the diaphragm 146, and hence the valve member 145 fixed to an inner peripheral edge of the mounting hole 1461 is firmly held at a radial center thereof. Therefore, vibrations of the valve member 145 with respect to the valve shaft 144 and a noise in association therewith are further reduced, and hence variations in flow rate of fluid may further be inhibited.

Since the gap δ in the axial direction between the outer peripheral surface of the supporting member 1445 and the caulked portions 1451e of the mounting portion 1451d is small, vibrations of the valve member 145 with respect to the valve shaft 144 and a noise in association thereto are reduced, and hence variations in flow rate of fluid may further be inhibited.

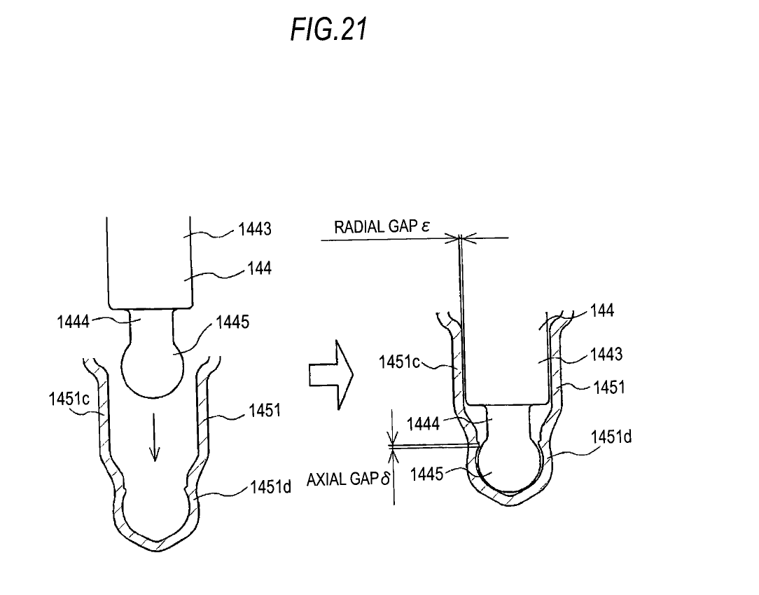

In the embodiments described above, the valve flame 1451 is mounted on the valve shaft 144 by caulking the mounting portion 1451d. However, in the embodiments disclosed here, the valve flame 1451 and the valve shaft 144 do not necessarily have to be connected by caulking. For example, instead of the caulking method, the valve flame 1451 and the valve shaft 144 may be connected by forming the valve flame 1451 of a spring steel and inserting the supporting member 1445 of the valve shaft 144 into the mounting portion 1451d while increasing the diameter of the mounting portion 1451d as illustrated in FIG. 21. In this case as well, it is needless to say that there are the gap δ in the axial direction between the supporting member 1445 and the mounting portion 1451d, and the radial gap ε between the column portion 1443 and the cylindrical portion 1451c.

### Embodiment 4

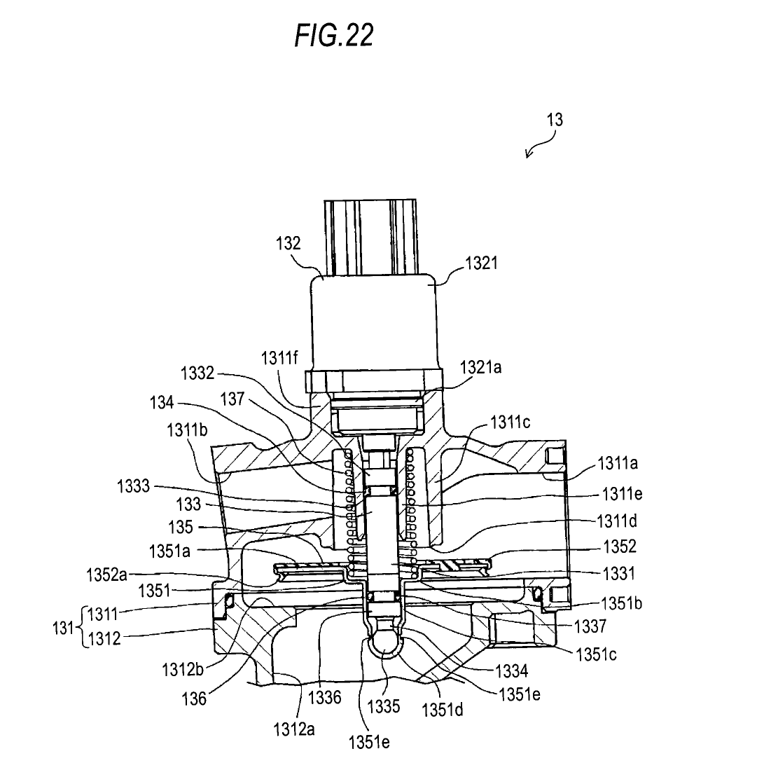

Subsequently, a structure of the three-way valve 13 (which corresponds to a fluid control valve) of Embodiment 4 will be described in detail with reference to FIG. 22 to FIG. 24. Upside and lower side in FIG. 22 are defined as upside and lower side of three-way valve 13, and right side and left side in FIG. 22 correspond to right side and left side of the three-way valve 13, respectively, in the description. However, these orientations have no relation to actual mounting directions of the three-way valve 3 in the vehicle.

As illustrated in FIG. 22, the three-way valve 13 is formed by mounting a motor assembly 132 (which corresponds to a drive source) to an outer peripheral surface of a valve housing 131 in the same manner as the air pressure regulation valve 14 of Embodiment 1. The valve housing 131 is formed by fitting a first body 1311 and a second body 1312 both formed of a synthetic resin material to each other in a liquid-tight manner.

The first body 1311 is formed with a three-way valve inlet 1311a (which corresponds to a inlet port) opening rightward in FIG. 22. The three-way valve inlet 1311a is connected to the inter cooler 24 via the oxygen system supply pipe 21a described above (illustrated in FIG. 1). The second body 1312 is formed with a three-way outlet 1312a (which corresponds to an outlet port) opening in the vertical direction with respect to the three-way valve inlet 1311a (opening downward in FIG. 22). The three-way outlet 1312a is connected to one end of the cathode flow channel 62 of the cell stack 6 via the oxygen system supply pipe 21a described above. The first body 1311 is formed with a bypass port 1311b opening leftward in FIG. 22. The bypass port 1311b is connected to the discharge gas diluter 56 via the bypass conduit line 21c described above (illustrated in FIG. 1).

On an inner peripheral surface of the second body 1312, a control valve seat 1312b (which corresponds to a valve seat) is formed between the three-way valve inlet 1311a and the three-way outlet 1312a. The control valve seat 1312b is formed into a flat-circular-ring shape.

A cylindrical seating body 1311c extends downward from an upper surface of the interior of the first body 1311. A lower end of the seating body 1311c is formed into a flat shape, and a bypass valve seat 1311d positioned between the three-way valve inlet 1311a, and the three-way outlet 1312a with respect to the bypass port 1311b is formed. From an upper surface of an inner peripheral surface of the first body 1311, a cylindrical shaft supporting portion 1311e projects so as to be positioned radially inward of the seating body 1311c.

In the same manner as the air pressure regulation valve 14 of Embodiment 3, the above-described motor assembly 132 is mounted on an upper surface of the valve housing 131. The motor assembly 132 is fixed to the first body 1311 by tightening a plurality of mounting screws, not illustrated, penetrated through the motor case 1321 to the first body 1311 in a state in which an outer peripheral surface of a mechanism storage 1321a of a motor case 1321 is fitted to an inner peripheral surface of a motor mounting boss 1311f formed on an upper end portion of the first body 1311. The mounting screws are loosely fitted into through holes (not illustrated) formed in the motor case 1321, and positioning of the motor assembly 132 is achieved by abutment of an outer peripheral surface of the mechanism storage 1321a with the inner peripheral surface of the motor mounting boss 1311f.

In the same manner as the air pressure regulation valve 14, the stepping motor 1422 is fixed to the interior of the motor case 1321, rotary motion of the output shaft 1422a of the stepping motor 1422 is converted into a translating motion and is transmitted to a valve shaft 133 (which corresponds to a valve shaft). The valve shaft 133 is supported on an inner peripheral surface of the above-described shaft supporting portion 1311e so as to be movable in the axial direction thereof.

A column portion 1331 extending in the axial direction so as to have a constant diameter is formed at a substantially center portion of the valve shaft 133 in the longitudinal direction. Also, a first land portion 1332 having the same diameter as that of the column portion 1331 is provided above the column portion 1331, and a first seal groove 1333 is formed on the circumference thereof between the column portion 1331 and the first land portion 1332. A seal packing 134 formed of a synthetic rubber material is fitted in the first seal groove 1333. The seal packing 134 delivers a sealing performance between an outer peripheral surface of the valve shaft 133 and the inner peripheral surface of the shaft supporting portion 1311e to prevent entry of water, foreign substances or the like into the motor assembly 132.

A substantially spherical shaped supporting member 1335 is integrally formed at a distal end portion of the cylindrical portion 1331 via a small-diameter bridge portion 1334. In the same manner as the air pressure regulation valve 14, a valve member 135 is mounted on the supporting member 1335. A valve frame 1351 of the valve member 135 includes a flat plate portion 1351a extending in a disk shape in the radial direction with respect to an axial center of the valve shaft 133, and the flat plate portion 1351a is covered with a seal member 1352 formed of a synthetic rubber material so as to cover an outer peripheral surface (an upper surface and an outer peripheral edge) thereof.

A seal lip 1352a configured to be capable of abutting against the control valve seat 1312b formed on the second body 1312 by a downward movement of the valve member 135 projects from a lower surface of the seal member 1352. As illustrated in FIG. 22, the seal lip 1352a is formed radially outward so as to achieve self-sealing by a negative pressure generated by a reaction between hydrogen gas remaining in the cell stack 6 and oxygen. Also, an upper surface of the seal member 1352 is formed to be flat, and may be brought into abutment with the bypass valve seat 1311d formed on the first body 1311 by an upward movement of the valve member 135.

The valve frame 1351 is formed with a depressed portion 1351b depressed toward a distal end of the valve shaft 133 (a configuration including the flat plate portion 1351a and the depressed portion 1351b corresponds to an extending portion) at a radially center of the flat plate portion 1351a. The valve frame 1351 includes a cylindrical portion 1351c (which corresponds to a cylindrical portion) continuing at one end thereof from an inner peripheral end of the depressed portion 1351b. The cylindrical portion 1351c extends in the vertical direction with respect to the flat plate portion 1351a, and the cylindrical portion 1331 of the valve shaft 133 is inserted therein.

In addition, the valve frame 1351 includes a mounting portion 1351d formed so as to be continuous with the other end of the cylindrical portion 1351c and configured to accept the supporting member 1335 of the valve shaft 133 in the same manner as the air pressure regulation valve 14. The mounting portion 1351d is mounted to the supporting member 1335 of the valve shaft 133 so as not to be decoupled therefrom by caulking.

In the same manner as the air pressure regulation valve 14, the valve flame 1351 is formed with the gap δ in the axial direction of the valve shaft 133 between an outer peripheral surface of the supporting member 1335 and the caulked portions 1351e of the mounting portion 1351d in state of being mounted on the valve shaft 133.

In a state in which the valve frame 1351 is mounted on the valve shaft 133, the radial gap ε with respect to the axial center of the valve shaft 133 is formed between an inner peripheral surface of the cylindrical portion 1351c and an outer peripheral surface of the cylindrical portion 1331 of the inserted valve shaft 133 on the entire circumference thereof.

In the valve shaft 133, a second land portion 1336 having the same diameter as that of the column portion 1331 is provided above the bridge portion 1334 described above, and a second seal groove 1337 is formed on the circumference thereof between a lower portion of the column portion 1331 and the second land portion 1336. A ring-shaped shaft seal 136 (which corresponds to a ring-shaped seal member) formed of a synthetic resin member is mounted in the second seal groove 1337. The shaft seal 136 delivers a sealing performance between the outer peripheral surface of the valve shaft 133 and the inner peripheral surface of the cylindrical portion 1351c of the valve frame 1351, and entry of water, foreign substances or the like into the cylindrical portion 1351c and the mounting portion 1351d of the valve frame 1351 is prevented.

The shaft seal 136 is resiliently provided between the outer peripheral surface of the valve shaft 133 and the inner peripheral surface of the cylindrical portion 1351c of the valve frame 1351, and a predetermined sliding resistance is generated therebetween. Therefore, the valve member 135 is held at the axial center of the valve shaft 133 (centering) by the shaft seal 136, so that vibrations of the valve member 135 with respect to the valve shaft 133 and a noise in association therewith may be reduced, and hence reduction of variations in flow rate of fluid passing through the interior of the three-way valve 13 is achieved.

A valve spring 137 (which corresponds to a coil spring) is interposed between the depressed portion 1351b of the valve frame 1351 and the upper surface of the interior of the first body 1311. An inner peripheral surface of the valve spring 137 is secured to an outer peripheral surface of the shaft supporting portion 1311e described above by being fitted thereto. The valve spring 137 is mounted resiliently between the valve frame 1351 and the first body 1311, and urges the valve member 135 toward the distal end of the valve shaft 133. By an urging force of the valve spring 137, when the three-way valve 13 is opened, the caulked portions 1351e of the valve flame 1351 come into abutment with the supporting member 1335 of the valve shaft 1334.

The valve member 135 is held without being displaced from the axial center of the valve shaft 133 (centering) and without being inclined about the axial center of the valve shaft 133 by an urging force of the valve spring 137. Also, in a state in which the valve member 135 is apart from the control valve seat 1312b, the gap δ in the axial direction between the valve frame 1351 an the valve shaft 133 is gone by the urging force of the valve spring 137 against a sliding resistance of the shaft seal 136. Therefore, generations of vibrations of the valve member 135 and a noise in association therewith may be prevented and hence variations in flow rate of the fluid passing through the interior of the three-way valve 13 may be reduced.

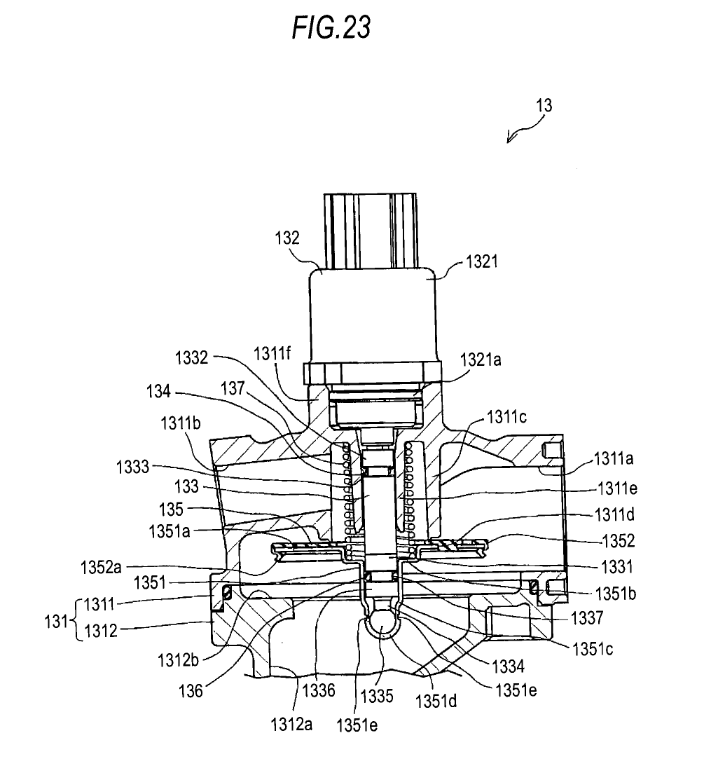

Subsequently, a method of operation of the three-way valve 13 will be described in brief. When the valve shaft 133 is positioned on an upper side, the upper surface of the seal member 1352 of the valve member 135 is seated on the bypass valve seat 1311d, and is apart from the control valve seat 1312b (illustrated in FIG. 23). At this time, the three-way valve inlet 1311a and the three-way outlet 1312a are in communication with each other, and hence mutual distribution of fluid such as air is allowed. In contrast, the communication between the three-way valve inlet 1311a and the three-way outlet 1312a with respect to the bypass port 1311b is cut off, so that the distribution of the fluid therebetween is interrupted. At this time, by an upper surface of the valve member 135 pressed from the bypass valve seat 1311d, the caulked portion 1351e of the valve frame 1351 is held in a state of abutment with the supporting member 1335 of the valve shaft 133.

In a case where accuracy of parallelism between seal surfaces of the seal member 1352 and the bypass valve seat 1311d varies when the seal member 1352 is seated on the bypass valve seat 1311d, the valve member 135 is inclined with respect to the valve shaft 133 about the supporting member 1335 of the valve shaft 133 while bending the valve spring 137 in conformity to the seal surface of the bypass valve seat 1311d, so that the sealing property between the valve member 135 and the bypass valve seat 1311d may be secured.

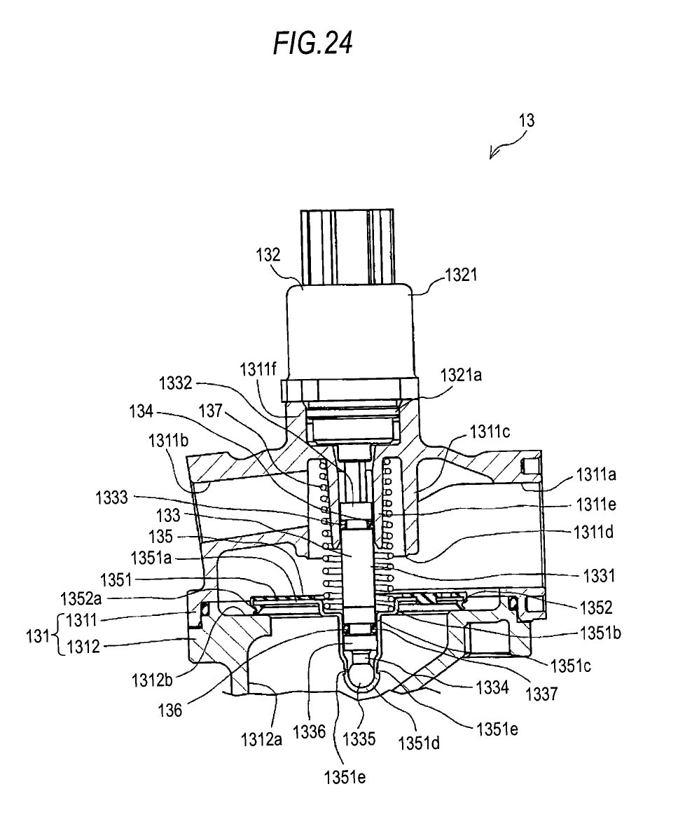

When the stepping motor rotates in one direction by a drive signal from the control apparatus 9, the valve member 135 moves downward in the axial direction together with the valve shaft 133, and the upper surface of the seal member 1352 moves away from the bypass valve seat 1311d and the seal lip 1352a is seated on the control valve seat 1312b (illustrated in FIG. 24). At this time, the three-way valve inlet 1311a and the bypass port 1311b are in communication with each other, and hence mutual distribution of fluid such as air is allowed. In contrast, the communication between the three-way valve inlet 1311a and the bypass port 1311b with respect to three-way outlet 1312a is cut off, so that the distribution of the fluid therebetween is interrupted. In this state, the valve spring 137 is compressed and presses the valve member 135 against the control valve seat 1312b by a predetermined urging force.

In a case where accuracy of parallelism between seal surfaces of both of the seal member 1352 and the control valve seat 1312b varies when the seal member 1352 is seated on the control valve seat 1312b, the valve member 135 is inclined with respect to the valve shaft 133 about the supporting member 1335 of the valve shaft 133 while bending the valve spring 137 in conformity to the seal surface of the control valve seat 1312b, so that the sealing property between the valve member 135 and the control valve seat 1312b may be secured.

In the three-way valve 13, the valve member 135 is capable of controlling the rates of flow of the fluid supplied from the three-way valve inlet 1311a split to the three-way outlet 1312a and the bypass port 1311b respectively on the basis of the cross-sectional area of a passage where the fluid passes by taking an arbitrary position between the control valve seat 1312b and the bypass valve seat 1311d (illustrated in FIG. 22).

According to this embodiment, the ring-shaped shaft seal 136 is resiliently interposed between the outer peripheral surface of the valve shaft 133 and the inner peripheral surface of the cylindrical portion 1351c, and hence a sliding resistance is generated between the valve shaft 133 and the valve member 135 by the shaft seal 136, and vibrations of the valve member 135 with respect to the valve shaft 133 and a noise in association therewith are reduced, and variations in flow rate of fluid may be inhibited.

### Other Embodiments

The invention is not limited to the embodiment described above, and modifications or extensions as described below may be made.

A configuration in which vibrations of the valve member 145 with respect to the valve shaft 144 and a noise in association therewith are reduced by interposing the seal member resiliently between an inner peripheral surface of the valve flame 1451 and the outer peripheral surface of the valve shaft 144 of the air pressure regulation valve 14 to inhibit the variations in flow rate of fluid is also applicable.

The supporting member 1445 formed at the distal end portion of the valve shaft 144 does not necessarily have to be spherical, and if the valve member 145 may be inclined smoothly with respect to the valve shaft 144, the supporting member 1445 may be formed into a semi-spherical shape or a smooth inverted conical shape.

In the valve members 135 and 145 illustrated in FIG. 13 and FIG. 22, a configuration in which the flat plate portions 1351a and 1451a are formed below the cylindrical portions 1351c and 1451c and the mounting portions 1351d and 1451d are formed below the flat plate portions 1351a and 1451a so as to continue from the flat plate portions 1351a and 1451a is also applicable.

What is claimed is:

1. A fluid control valve comprising:
a valve housing having an inlet port and an outlet port for fluid formed in the interior thereof;
a drive source mounted on the valve housing;
a valve shaft configured to be moved by the drive source in the axial direction in the valve housing; and
a valve member mounted so as to extend radially with respect to an axial center of the valve shaft, configured to be seated on or moved away from a valve seat formed in the valve housing on one surface by moving together with the valve shaft to connect and disconnect between the inlet port and the outlet port, wherein
the valve member includes:
a valve frame having a cylindrical portion configured to allow insertion of the valve shaft in a state in which a radial gap is formed with respect to the valve shaft, an extending portion spreading radially from the cylindrical portion to the valve shaft, and a mounting portion continuing at one end thereof from the cylindrical portion or the extending portion and closed at the other end thereof in a bag shape, and having a distal end of the valve shaft housed therein, and
a seal member mounted on the extending portion and configured to be capable of coming into abutment with the valve seat,
a portion of the valve shaft housed in the mounting portion is formed with a through hole in the direction orthogonal to the axial center, and a rotatable spherical body is arranged in the through hole, and
the mounting portion is fixed to the spherical body by caulking.

2. The fluid control valve according to claim 1, wherein
a portion of the valve shaft formed with the through hole is formed to have a diameter smaller than that of a portion inserted into the cylindrical portion, and
the spherical body projects from both end portion of the through hole.

3. The fluid control valve according to claim 2, wherein
the portion of the valve shaft formed with the through hole is formed into a width-across-flat shape having a pair of flat surfaces facing each other on an outer peripheral surface thereof, and
the both end portions of the through hole are opened respectively so as to be orthogonal to the flat surfaces facing each other.

4. The fluid control valve according to claim 1, wherein
the ring-shaped seal member is interposed between the outer peripheral surface of the valve shaft and an inner peripheral surface of the cylindrical portion.

5. A fluid control valve comprising:
a valve housing having an inlet port and an outlet port for fluid formed in the interior thereof;
a drive source mounted on the valve housing;
a valve shaft configured to be moved by the drive source in the axial direction in the valve housing;
a valve member mounted so as to extend radially with respect to an axial center of the valve shaft, configured to be seated on or moved away from a valve seat formed in the valve housing on one surface by moving together with the valve shaft to connect and disconnect between the inlet port and the outlet port, wherein
the valve member includes:
a valve frame having a cylindrical portion extending in the axial direction of the valve shaft and configured to allow insertion of the valve shaft, an extending portion spreading radially from the cylindrical portion to the valve shaft, and a mounting portion continuing at one end thereof from the cylindrical portion or the extending portion and closed at one end thereof in a bag shape, and configured to receive a curved surface formed on a distal end portion of the valve shaft; and
a seal member mounted on the extending portion and configured to be capable of coming into abutment with the valve seat, and
the valve shaft has a radial gap with respect to the cylindrical portion, is connected to the mounting portion so as not to be decoupled, and has a gap in the axial direction.

6. The fluid control valve according to claim 5, wherein
the valve frame is formed by press-forming a metal plate, is configured to connect the valve member and the valve shaft by caulking the mounting portion after the distal end portion of the valve shaft is inserted, and forms the gap in the axial direction.

7. The fluid control valve according to claim 5, wherein
the size of the gap in the radial direction between the valve shaft and the cylindrical portion is set on the basis of a seal diameter with respect to the valve seat of the seal member so that the valve member is inclined with respect to the valve shaft by a predetermined amount about the distal end portion of the valve shaft in conformity to the valve seat when the valve member is seated on the valve seat.

8. The fluid control valve according to claim 5, comprising: a coil spring interposed between the valve member and the valve housing so as to surround the valve shaft in the circumferential direction and configured to urge the valve member toward a distal end of the valve shaft.

9. The fluid control valve according to claim 5, wherein
the ring-shaped seal member is resiliently interposed between the outer peripheral surface of the valve shaft and an inner peripheral surface of the cylindrical portion.

10. The fluid control valve according to claim 5, wherein
an outer peripheral edge of a diaphragm having a mounting hole penetrating therethrough from the front to the back is fixed to an inner peripheral surface of the valve housing in a liquid-tight manner, and
an inner peripheral edge of the mounting hole is fixed to an outer peripheral portion of the valve member in a liquid-tight manner, so that the interior of the valve housing is divided by the diaphragm and the valve member to form a fluid chamber having the inlet port, the outlet port, and the valve seat and configured to allow passage of the fluid, and an air chamber configured to prevent the fluid from entering therein.
